(19) United States
(12) Patent Application Publication
(10) Pub. No.: US 2026/0303237 A1
(43) Pub. Date: Oct. 1, 2026

(54) BEAM PREDICTION PERFORMANCE MONITORING BASED ON REFERENCE SIGNAL RECEIVE POWER FEEDBACK

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Hamed PEZESHKI, San Diego, CA (US)

(21) Appl. No.: 19/483,216

(22) PCT Filed: Aug. 2, 2023
(86) PCT No.: PCT/CN2023/110661

§ 371 Date: Nov. 10, 2025

(51) Int. Cl. H04B 17/318; H04B 7/06; H04L 1/1867; H04L 5/00

(52) U.S. Cl. CPC H04B 17/328; H04B 7/06952; H04L 1/1896; H04L 5/0044

(57) ABSTRACT

Methods, systems, and devices for wireless communications are described. Some wireless communications systems may support reference signal receive power (RSRP) reporting based on measurement of one or more demodulation reference signals (DMRSs) associated with downlink control channels or downlink data channels. A user equipment (UE) may receive a request to provide feedback information that includes one or more RSRP values measured from the one or more respective DMRSs. The request may further include at least one reference RSRP value that the UE may use to quantize the RSRP values. The UE may then perform RSRP measurement reporting and may transmit the feedback information which includes at least a portion of the one or more RSRP values. In such cases, the feedback information may be quantized with respect to the at least one reference RSRP value.

### CROSS REFERENCE

The present Application for Patent is a 371 national phase filing of International Patent Application No. PCT/CN2023/110661 by LI et al., entitled “BEAM PREDICTION PERFORMANCE MONITORING BASED ON REFERENCE SIGNAL RECEIVE POWER FEEDBACK,” filed Aug. 2, 2023, assigned to the assignee hereof, and expressly incorporated by reference herein.

### FIELD OF TECHNOLOGY

The following relates to wireless communications, including beam prediction performance monitoring based on reference signal receive power (RSRP) feedback.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support beam prediction performance monitoring based on reference signal receive power (RSRP) feedback. For example, the described techniques may provide for efficient demodulation reference signal (DMRS)-based RSRP feedback reporting for beam management and channel quality monitoring. A wireless device such as a user equipment (UE) may receive a request for feedback information that includes one or more RSRP measurement values associated with one or more respective DMRSs of a downlink channel (e.g., a physical downlink shared channel (PDSCH), a physical downlink control channel (PDCCH), or both). In some cases, the request may further include at least one reference RSRP value that the UE may use to differentially quantize the one or more RSRP measurement values to a RSRP measurement report. The UE may then perform RSRP measurements on the downlink channel DMRS, and may transmit (e.g., responsive to the request) the feedback information that is indicative of at least a portion of the one or more RSRP values. In some examples, the UE may quantize the feedback with respect to the at least one reference RSRP value.

A method for wireless communications by a UE is described. The method may include receiving a request for feedback information that is based on one or more RSRP values associated with one or more respective DMRSs of a downlink channel, the request further including at least one reference RSRP value and transmitting, responsive to the request, the feedback information that is indicative of at least a portion of the one or more RSRP values, where the feedback information is quantized with respect to the at least one reference RSRP value.

A UE for wireless communications is described. The UE may include one or more memories storing processor executable code, and one or more processors coupled with the one or more memories. The one or more processors may individually or collectively operable to execute the code to cause the UE to receive a request for feedback information that is based on one or more RSRP values associated with one or more respective DMRSs of a downlink channel, the request further including at least one reference RSRP value and transmit, responsive to the request, the feedback information that is indicative of at least a portion of the one or more RSRP values, where the feedback information is quantized with respect to the at least one reference RSRP value.

Another UE for wireless communications is described. The UE may include means for receiving a request for feedback information that is based on one or more RSRP values associated with one or more respective DMRSs of a downlink channel, the request further including at least one reference RSRP value and means for transmitting, responsive to the request, the feedback information that is indicative of at least a portion of the one or more RSRP values, where the feedback information is quantized with respect to the at least one reference RSRP value.

A non-transitory computer-readable medium storing code for wireless communications is described. The code may include instructions executable by a processor to receive a request for feedback information that is based on one or more RSRP values associated with one or more respective DMRSs of a downlink channel, the request further including at least one reference RSRP value and transmit, responsive to the request, the feedback information that is indicative of at least a portion of the one or more RSRP values, where the feedback information is quantized with respect to the at least one reference RSRP value.

In some examples of the method, user UEs, and non-transitory computer-readable medium described herein, the one or more RSRP values associated with the one or more respective DMRSs correspond to a downlink shared channel, a control channel search space, or control resource set associated with the UE.

In some examples of the method, UEs, and non-transitory computer-readable medium described herein, transmitting the feedback information may include operations, features, means, or instructions for transmitting the feedback information that may be indicative of at least a portion of the one or more RSRP values, where the portion of the one or more RSRP values includes RSRP values measured from a set of successfully decoded control channel candidates.

Some examples of the method, UEs, and non-transitory computer-readable medium described herein may further include operations, features, means, or instructions for receiving a downlink control information (DCI) message scheduling the one or more respective DMRSs of the downlink channel, where one or more fields of the DCI message include the request for feedback information multiplexed with hybrid automatic repeat request (HARQ) feedback for the DCI message and transmitting, responsive to the request, the feedback information multiplexed with one or more HARQ messages.

Some examples of the method, user UEs, and non-transitory computer-readable medium described herein may further include operations, features, means, or instructions for transmitting the feedback information multiplexed with one or more HARQ messages based on a format of the DCI message that triggers transmission of the feedback information, a radio network temporary identifier that triggers transmission of the feedback information, or both.

Some examples of the method, UEs, and non-transitory computer-readable medium described herein may further include operations, features, means, or instructions for receiving a radio resource control (RRC) message, a medium access control-control element (MAC-CE), or both, that activate the one or more fields of the DCI message, where transmission of the feedback information with the one or more HARQ messages may be based on an activation or deactivation of the one or more fields of the DCI message.

Some examples of the method, UEs, and non-transitory computer-readable medium described herein may further include operations, features, means, or instructions for receiving an RRC configuration including a semi-persistent scheduling for the one or more respective DMRSs of the downlink channel, where the RRC configuration further includes the request for feedback information multiplexed with HARQ feedback for the RRC configuration and transmitting, responsive to the request, the feedback information multiplexed with one or more HARQ messages.

Some examples of the method, UEs, and non-transitory computer-readable medium described herein may further include operations, features, means, or instructions for receiving a DCI message that activates the semi-persistent scheduling and further indicates activation of the RRC configuration and corresponding HARQ feedback.

Some examples of the method, UEs, and non-transitory computer-readable medium described herein may further include operations, features, means, or instructions for receiving a MAC-CE that activates the request for feedback information multiplexed with HARQ feedback for the MAC-CE and transmitting, responsive to the request, the feedback information multiplexed with one or more HARQ messages.

In some examples of the method, UEs, and non-transitory computer-readable medium described herein, the MAC-CE further includes a serving cell identifier, a bandwidth part identifier, or both, for separate or joint activation via the MAC-CE.

In some examples of the method, UEs, and non-transitory computer-readable medium described herein, transmitting the feedback information may include operations, features, means, or instructions for multiplexing the feedback information that may be indicative of at least a portion of the one or more RSRP values with one or more HARQ feedback bits associated with the downlink channel.

Some examples of the method, UEs, and non-transitory computer-readable medium described herein may further include operations, features, means, or instructions for receiving a DCI message scheduling the one or more respective DMRSs of the downlink channel, where one or more fields of the DCI message include the at least one reference RSRP value.

Some examples of the method, UEs, and non-transitory computer-readable medium described herein may further include operations, features, means, or instructions for receiving an RRC message or a MAC-CE to activate the one or more fields of the DCI message, where the RRC message or the MAC-CE further indicates the at least one reference RSRP value.

Some examples of the method, UEs, and non-transitory computer-readable medium described herein may further include operations, features, means, or instructions for receiving an RRC configuration including a semi-persistent scheduling for the one or more respective DMRSs of the downlink channel, where the RRC configuration further includes the at least one reference RSRP value.

Some examples of the method, UEs, and non-transitory computer-readable medium described herein may further include operations, features, means, or instructions for receiving a DCI message that activates the semi-persistent scheduling and includes the at least one reference RSRP value.

Some examples of the method, UEs, and non-transitory computer-readable medium described herein may further include operations, features, means, or instructions for quantizing the feedback information with respect to the at least one reference RSRP value using a quantity of bits, where the quantity of bits may be a defined value or may be received via the request.

Some examples of the method, UEs, and non-transitory computer-readable medium described herein may further include operations, features, means, or instructions for receiving an RRC message or a MAC-CE including one or more configurations of a channel state information (CSI) report setting for persistent CSI reporting, semi-persistent CSI reporting, or both and transmitting, during a CSI reporting occasion, the feedback information that may be indicative of an average of the one or more RSRP values associated with a set of quasi-colocated DMRSs of the one or more respective DMRSs.

In some examples of the method, UEs, and non-transitory computer-readable medium described herein, the set of quasi-colocated DMRSs may be associated with a quasi-colocation source that may be based on one or more synchronization signal blocks, one or more channel state information-reference signals (CSI-RSs), one or more virtual resources, one or more transmission configuration indicator state identifiers, or any combination thereof.

Some examples of the method, UEs, and non-transitory computer-readable medium described herein may further include operations, features, means, or instructions for receiving a DCI including one or more configurations of a CSI report setting for aperiodic CSI reporting and transmitting, during a CSI reporting occasion, the feedback information that may be indicative of at least the portion of the one or more RSRP values associated with a set of quasi-colocated DMRSs of the one or more respective DMRSs.

Some examples of the method, UEs, and non-transitory computer-readable medium described herein may further include operations, features, means, or instructions for receiving a channel state information reporting configuration via an RRC message, a MAC-CE, a DCI message, or a combination thereof, where the channel state information reporting configuration includes the at least one reference RSRP value.

Some examples of the method, UEs, and non-transitory computer-readable medium described herein may further include operations, features, means, or instructions for transmitting the feedback information that may be indicative of at least the portion of the one or more RSRP values, where the one or more RSRP values may be associated with respective quasi-colocation sources of the one or more respective DMRSs and may be multiplexed with one or more HARQ bits.

Some examples of the method, UEs, and non-transitory computer-readable medium described herein may further include operations, features, means, or instructions for transmitting the feedback information that may be indicative of at least the portion of the one or more RSRP values, where the one or more RSRP values may be associated with respective quasi-colocation sources of the one or more respective DMRSs and may be transmitted in accordance with one or more channel state information reports.

Some examples of the method, UEs, and non-transitory computer-readable medium described herein may further include operations, features, means, or instructions for transmitting a capability message that indicates one or more capabilities of the UE to perform control channel-based RSRP feedback reporting, data channel-based RSRP feedback reporting, HARQ bit multiplexing with RSRP feedback reporting, channel state information-based RSRP feedback reporting, RSRP feedback reporting associated with multiple quasi-colocation sources, or any combination thereof.

In some examples of the method, UEs, and non-transitory computer-readable medium described herein, the downlink channel includes a physical downlink shared channel or a physical downlink control channel.

In some examples of the method, UEs, and non-transitory computer-readable medium described herein, the one or more RSRP values include layer-one (L1) RSRP values.

A method for wireless communications by a network entity is described. The method may include transmitting a request for feedback information that is based on one or more RSRP values associated with one or more respective DMRSs of a downlink channel, the request further including at least one reference RSRP value and receiving, responsive to the request, the feedback information that is indicative of at least a portion of the one or more RSRP values, where the feedback information is quantized with respect to the at least one reference RSRP value.

A network entity for wireless communications is described. The network entity may include one or more memories storing processor executable code, and one or more processors coupled with the one or more memories. The one or more processors may individually or collectively operable to execute the code to cause the network entity to transmit a request for feedback information that is based on one or more RSRP values associated with one or more respective DMRSs of a downlink channel, the request further including at least one reference RSRP value and receive, responsive to the request, the feedback information that is indicative of at least a portion of the one or more RSRP values, where the feedback information is quantized with respect to the at least one reference RSRP value.

Another network entity for wireless communications is described. The network entity may include means for transmitting a request for feedback information that is based on one or more RSRP values associated with one or more respective DMRSs of a downlink channel, the request further including at least one reference RSRP value and means for receiving, responsive to the request, the feedback information that is indicative of at least a portion of the one or more RSRP values, where the feedback information is quantized with respect to the at least one reference RSRP value.

A non-transitory computer-readable medium storing code for wireless communications is described. The code may include instructions executable by a processor to transmit a request for feedback information that is based on one or more RSRP values associated with one or more respective DMRSs of a downlink channel, the request further including at least one reference RSRP value and receive, responsive to the request, the feedback information that is indicative of at least a portion of the one or more RSRP values, where the feedback information is quantized with respect to the at least one reference RSRP value.

Some examples of the method, network entities, and non-transitory computer-readable medium described herein may further include operations, features, means, or instructions for performing a beam prediction based on a comparison of the received feedback information to a set of predicted RSRP values.

Some examples of the method, network entities, and non-transitory computer-readable medium described herein may further include operations, features, means, or instructions for transmitting a DCI message scheduling the one or more respective DMRSs of the downlink channel, where one or more fields of the DCI message include the request for feedback information multiplexed with HARQ feedback for the DCI and receiving, responsive to the request, the feedback information multiplexed with one or more HARQ messages.

### BRIEF DESCRIPTION OF THE DRAWINGS

FIGS. 1 and 2 show examples of wireless communications systems that supports beam prediction performance monitoring based on reference signal receive power (RSRP) feedback in accordance with one or more aspects of the present disclosure.

FIGS. 3, 4, and 5 show examples of demodulation reference signal (DMRS)-based RSRP reporting configurations that support beam prediction performance monitoring based on RSRP feedback in accordance with one or more aspects of the present disclosure.

FIG. 6 shows an example of a process flow that supports beam prediction performance monitoring based on RSRP feedback in accordance with one or more aspects of the present disclosure.

FIGS. 7 and 8 show block diagrams of devices that support beam prediction performance monitoring based on RSRP feedback in accordance with one or more aspects of the present disclosure.

FIG. 9 shows a block diagram of a communications manager that supports beam prediction performance monitoring based on RSRP feedback in accordance with one or more aspects of the present disclosure.

FIG. 10 shows a diagram of a system including a device that supports beam prediction performance monitoring based on RSRP feedback in accordance with one or more aspects of the present disclosure.

FIGS. 11 and 12 show block diagrams of devices that support beam prediction performance monitoring based on RSRP feedback in accordance with one or more aspects of the present disclosure.

FIG. 13 shows a block diagram of a communications manager that supports beam prediction performance monitoring based on RSRP feedback in accordance with one or more aspects of the present disclosure.

FIG. 14 shows a diagram of a system including a device that supports beam prediction performance monitoring based on RSRP feedback in accordance with one or more aspects of the present disclosure.

FIGS. 15 through 19 show flowcharts illustrating methods that support beam prediction performance monitoring based on RSRP feedback in accordance with one or more aspects of the present disclosure.

### DETAILED DESCRIPTION

In some wireless communications systems, reference signal receive power (RSRP) measurement is performed and reported by a user equipment (UE) via a measurement reporting. Such RSRP measurement reporting may allow the network to monitor channel quality at the UE and perform beam management to maintain ongoing communications. The UE may report RSRP measurements at Layer 1 (L1) (e.g., the physical layer) and Layer 3 (e.g., the radio resource control (RRC) Layer). L1-RSRP measurements may be used for beam management procedures, and measurements may be performed at the beam-level such that a network entity may perform beam prediction and monitoring using feedback information (including the RSRP measurements) from the UE.

In some implementations, the UE may perform L1-RSRP measurements using synchronization signals or channel state information (CSI) reference signals.

Additionally or alternatively, the UE may perform the L1-RSRP measurements on demodulation reference signals (DMRSs) associated with a downlink channel such as a physical downlink shared channel (PDSCH) or a physical downlink control channel (PDCCH) (e.g., “PDxCH), which may allow for efficient L1-RSRP measurement and feedback reporting. In such cases, the network may send an explicit feedback request for the UE to provide L1-RSRP measurement results based on DMRSs associated with a downlink channel. This request may also include additional information such as a reference L1-RSRP value that the UE may use to differentially quantize the measured L1-RSRPs in the report based on payload or overhead restrictions.

In some examples, the UE may receive the feedback request via a downlink control information (DCI) message, an RRC message, or a medium access control-control element (MAC-CE), and may multiplex the L1-RSRP measurements with HARQ-ACK information for the DCI, RRC, or MAC-CE, respectively. In some other examples, the feedback request may provide quantization information so that the UE may quantize the L1-RSRPs into different quantities of bits, or based on a reference RSRP value. In some other examples, the feedback request may request UE feedback of the L1-RSRP measurement results using CSI reporting. Additionally or alternatively, the UE may transmit L1-RSRP measurements in cases of multi-port DMRS or in cases where the DMRSs are associated with multiple quasi-colocation sources.

Aspects of the disclosure are initially described in the context of wireless communications systems. Aspects of the disclosure are further illustrated by and described with reference to DMRS-based RSRP reporting configurations, a process flow, apparatus diagrams, system diagrams, and flowcharts that relate to beam prediction performance monitoring based on RSRP feedback.

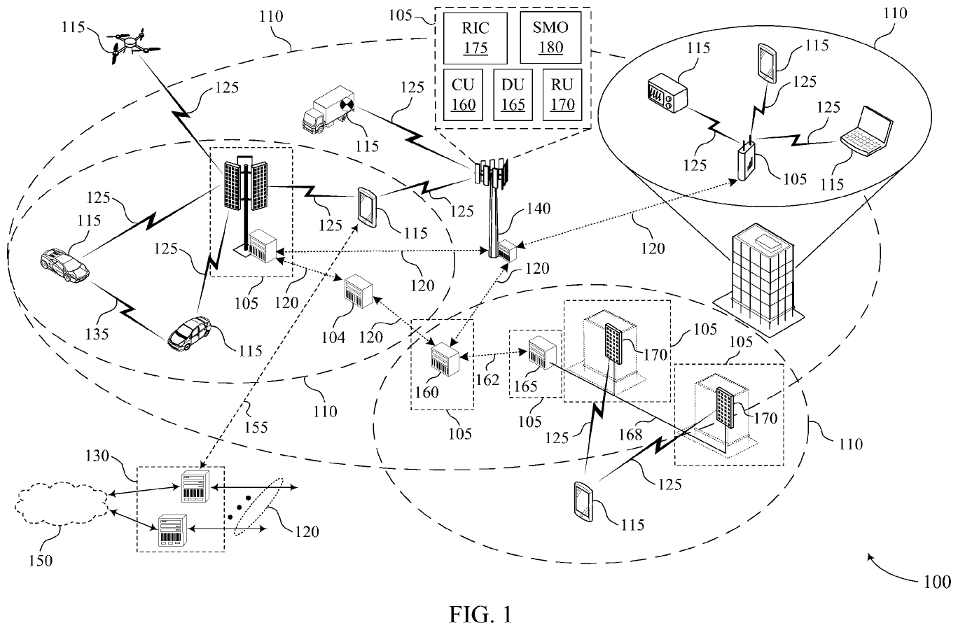

FIG. 1 shows an example of a wireless communications system 100 that supports beam prediction performance monitoring based on RSRP feedback in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support beam prediction performance monitoring based on RSRP feedback as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may perform beam management to access, maintain, and recover beams for communication within the wireless communications system 100. For example, the UE 115 may perform ongoing beam management due to changing environments (e.g., mobility of the UE 115, blockage, and orientation changes). Beam management may be defined as a set of Layer 1 (e.g., physical layer) and Layer 2 (e.g., medium access control) procedures to acquire and maintain a set of beam pair links (e.g., a beam used at one or more network-side TRPs) paired with a beam used at the UE 115.

Beam management procedures may begin when the UE 115 transitions out of an RRC idle or RRC inactive state (e.g., where the UE 115 is still receiving tracking reference signaling) and performs an initial access procedure. The initial access procedure may include beam sweeping (e.g., synchronization signal block (SSB) transmission and reception) and contention-based random access, where the UE 115 transitions to an RRC connected state. The UE 115 may then perform beam measurement and reporting to select a candidate beam, and then may perform one or more beam management procedures. Some possible beam management procedure may include P1/P2/P3 (e.g., SSB/CSI-RS tracking) procedures, U1/U2/U3 (e.g., SRS tracking) procedures, L1-RSRP reporting, TCI state configuration indication, L1-SINR reporting, overhead and latency reduction techniques such as component carrier group beam updates and enhanced uplink beam updates, unified TCI state implementations, L1/L2 centric mobility, dynamic TCI state updating, uplink multi-panel selection, maximum permissible exposure mitigation, beam management latency reduction, high speed and single frequency network implementations, multi-TRP beam management, artificial intelligence-based and machine learning-based beam management, among other beam management procedures.

In some examples, the UE 115 may perform measurements during beam management to detect possible beam failure and to initiate beam recovery. For example, the UE 115 may perform various beam failure recovery techniques such as beam failure detection and beam failure recovery for primary cell (PCell) and primary-secondary cell (PSCell), beam failure detection via a beam failure detection reference signal and PDCCH block error rate, contention-free random access-based beam failure detection, link recovery request via scheduling request, and MAC-CE-based beam failure recovery, artificial intelligence-based and machine learning-based beam failure recovery techniques, among other beam failure recovery procedures. In some examples, if beam failure recovery fails, the UE 115 may support radio link failure recovery to re-establish an active connection with the network.

In some cases, the UE 115 may support machine learning and artificial intelligence-based beam management for air interface implementations. For example, the UE 115 may utilize machine learning and artificial intelligence techniques to perform beam prediction in a time domain, in a spatial domain, or both, which may reduce signaling overhead and latency, along with beam selection accuracy improvement. In some examples, artificial intelligence and machine learning models may be trained, deployed, inferred, monitored, and updated by the network based on service quality or other network requirements. In some examples, a network entity 105 may configure one or more sets of beams to be measured (e.g., as a set of reference beams) based on machine learning and artificial intelligence-based models. In some other examples, the network entity 105 may use machine learning and artificial intelligence-based models to predict a set of “best” beams (e.g., beams with a highest relative signal strength) and may compare the predicted beams to a set of L1-RSRP measurements in order to efficiently identify and select a best beam.

A UE 115 may perform RSRP measurement reporting which may allow a network entity 105 to monitor channel quality at the UE 115. The UE 115 may report L1-RSRP measurements such that the network entity 105 may perform beam-prediction and monitoring using feedback information (including the RSRP measurements) from the UE. In some implementations, the UE may perform L1-RSRP on DMRSs associated with a downlink channel such as a PDSCH, a PDCCH, or both, which may allow for efficient L1-RSRP measurement and feedback reporting. In such cases, the network may send an explicit feedback request for the UE 115 to provide L1-RSRP measurement results based on DMRSs associated with a downlink channel. This request may also include additional information such as a reference L1-RSRP value that the UE 115 may use to differentially quantize the measured L1-RSRPs in the report based on payload or overhead restrictions.

In some examples, the UE 115 may receive the feedback request via a DCI message, an RRC message, or a MAC-CE, and may multiplex the L1-RSRP measurements with HARQ-ACK information for the DCI, RRC, or MAC-CE, respectively. In some other examples, the feedback request may provide quantization information so that the UE 115 may quantize the L1-RSRPs into different quantities of bits, or based on a reference RSRP value. In some other examples, the feedback request may request UE feedback of the L1-RSRP measurement results using CSI reporting.

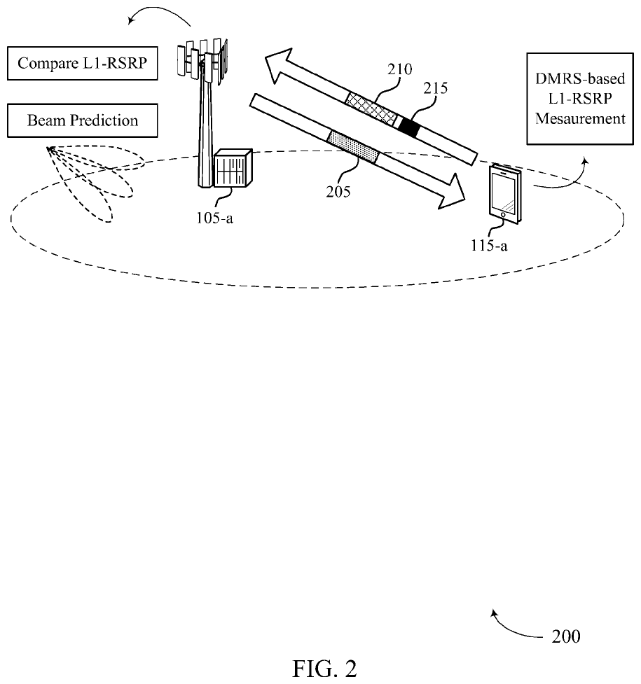

FIG. 2 shows an example of a wireless communications system 200 that supports beam prediction performance monitoring based on RSRP feedback in accordance with one or more aspects of the present disclosure. For example, wireless communications system 200 may support communications between a network entity 105-a and a UE 115-a, which may be examples of network entities 105 and UEs 115 described with reference to FIG. 1. The UE 115-a may in some examples support layer 1 (L1) RSRP (e.g., L1-RSRP) reporting (e.g., physical layer RSRP reporting) based on measurements performed on DMRS of a downlink channel.

Wireless communications system 200 may support L1-RSRP measurement reporting for performance monitoring and beam management at the UE 115-a and the network entity 105-a. For example, the UE 115-a may monitor a beam indicated as having an active TCI state for a downlink channel (e.g., PDSCH or PDCCH) DMRS, and may send measurement reporting to the network entity 105-a based on the collected L1-RSRP measurements. In some examples, the network entity 105-a may use the L1-RSRP measurements to perform network-side L1-RSRP prediction by comparing UE-measured L1-RSRP against L1-RSRP values predicted by the network entity 105-a regarding the same beam. For example, the network entity 105-a may perform a time-domain beam prediction for L1-RSRP of a first CSI-RS, and may predict the L1-RSRP to be a first value (e.g., −96dBm) at some time in the future (e.g., 20 ms later). The network entity 105-a may then indicate to the UE 115-a that the active TCI state associated with the downlink channel (e.g., PDSCH or PDCCH) is associated with the first CSI-RS based on the prediction made by the network entity 105-a. In some examples, the network entity 105-a may request that the UE 115-a measures and reports L1-RSRP associated with the downlink channel DMRS so that the network entity 105-a may compare the UE-reported L1-RSRP with the predicted L1-RSRP. In such cases, the network entity 105-a may verify its beam prediction accuracy performance based on the comparison.

In some implementations, the UE 115-a may measure and report L1-RSRP measurements (e.g., physical layer beam-level measurements) so that the network entity 105-a can monitor ongoing channel quality at the UE 115-a. In some cases, the UE 115-a may measure L1-RSRP using SSBs, CSI-RSs, or DMRS. In some other cases, L1-RSRP feedback may be triggered by receipt of a downlink grant (e.g., either a DCI or SPS grant), and the UE 115-a may multiplex the L1-RSRP measured from the scheduled downlink channel together with HARQ-ACK feedback bits corresponding to the same downlink channel. To reduce overhead (where feedback may be multiplexed on PUCCH), the network entity 105-a may in some cases transmit assistance information to the UE 115-a so that the UE may differentially quantize the L1-RSRP feedback based on one or more reference L1-RSRPs.

The network entity 105-a may transmit, to the UE 115-a, a downlink message 205 that includes a request for the UE 115-a to feedback or provide L1-RSRP measurement results based on measurements performed for PDCCH DMRS, PDSCH DMRS, or both. In some examples, the downlink message 205 may be associated with joint or separate network entity signaling and may additionally or alternatively include information (e.g., assistance information) that the UE 115-a may use to differentially quantize the measured one or more L1-RSRPs using one or more reference RSRP values. For example, the UE 115-a may quantize an RSRP report relative to the one or more reference RSRPs in order to reduce signaling overhead.

The UE 115-a may receive the downlink message 205 and may perform the DMRS-based downlink channel L1-RSRP measurements, and may transmit a feedback message 210 to the network entity 105-a, which includes the one or more L1-RSRP measurements. Once the network entity 105-a receives the L1-RSRP measurements from the UE 115-a, the network entity 105-a may compare the L1-RSRP measurements to a set of predicted L1-RSRP measurements that the network entity 105-a predicts using, for example, previous measurement reporting, artificial intelligence models, machine learning models, or a combination thereof. The network entity 105-a may then perform beam prediction to predict a “best” beam (e.g., a beam with highest RSRP or relative signal strength) to use for communications with the UE 115-a, and may schedule a corresponding downlink channel (e.g., PDSCH, PDCCH) using the predicted beam.

In some examples, the downlink message 205 (including the feedback request) may be a DCI message, an RRC message, or a MAC-CE, and the UE 115-a may multiplex the feedback message 210 (including the L1-RSRP measurements) with HARQ-ACK information for the DCI message, RRC message, or MAC-CE, respectively. In some other examples, the feedback request may provide quantization information so that the UE 115-a may quantize the L1-RSRPs into different quantities of bits, or based on the reference RSRP value. In some other examples, the feedback request may request UE feedback of the L1-RSRP measurement results using CSI reporting.

In some examples, the UE 115-a may measure L1-RSRPs of the downlink channel DMRS (e.g., PDCCH-DMRS) corresponding to a downlink shared channel (PDSCH), its own PDCCH search space, a control resource set (CORESET), or a combination thereof. In some other examples, the UE 115-a may include DMRS L1-RSRPs measured from successfully decoded PDCCH candidates, while the DMRS L1-RSRP measured from PDCCH candidates that are unsuccessfully decoded may not be included in the feedback message 210.

To increase coordination between the UE 115-a and the network entity 105-a, in some examples the UE 115-a may transmit a capability message 215 that indicates one or more capabilities of the UE 115-a for DMRS based L1-RSRP reporting. For example, the capability message 215 may include an indication of whether the UE 115-a supports PDCCH-DMRS based L1-RSRP reporting, PDSCH-DMRS based L1-RSRP reporting, PDCCH-DMRS/PDSCH-DMRS based L1-RSRP reporting multiplexed with HARQ-ACK bits, PDCCH-DMRS/PDSCH-DMRS based L1-RSRP reporting requested via CSI reporting (e.g., further based on reporting whether the UE 115-a supports aperiodic, semi-periodic, or aperiodic CSI reporting). Additionally or alternatively, the capability message 215 may indicate whether the UE 115-a supports PDSCH-DMRS based L1-RSRP reporting associated with multiple different quasi-colocation (QCL) sources (e.g., TypeD-QCL sources), where the DMRS includes multiple ports that may be associated with different types of QCL sources. In such cases, the UE 115-a may report a maximum number of TypeD-QCL sources supported for the PDSCH-DMRS.

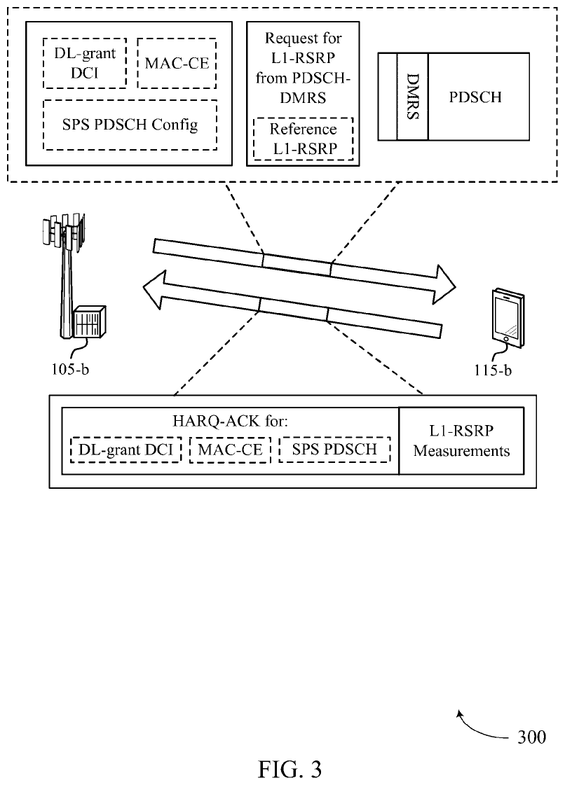

FIG. 3 shows an example of a DMRS-based RSRP reporting configuration 300 that supports beam prediction performance monitoring based on RSRP feedback in accordance with one or more aspects of the present disclosure. For example, the DMRS-based RSRP reporting configuration 300 may support communications between a network entity 105-b and a UE 115-b, which may be examples of network entities 105 and UEs 115 described with reference to FIGS. 1 and 2. The UE 115-b may in some examples support L1-RSRP reporting based on measurements performed on DMRS of a downlink channel.

In some examples, the network entity 105-b may transmit, to the UE 115-b, a downlink message (such as a DCI message, and RRC message, a MAC-CE, or any combination thereof) that includes a request for the UE 115-b to feedback or provide L1-RSRP measurement results based on measurements performed for PDCCH DMRS, PDSCH DMRS, or both. In some examples, the request may further include instructions for the UE 115-b to multiplex the L1-RSRP measurements with one or more HARQ-ACK bits corresponding to the DCI message, the RRC message, or the MAC-CE.

In some examples, the network entity 105-b may transmit the request for DMRS-based L1-RSRP reporting via a DCI message or a downlink grant DCI that schedules the corresponding PDSCH-DMRS. In such cases, the request may be included in one or more bit fields of the downlink grant DCI. The UE 115-b may measure and report L1-RSRP feedback based on the PDSCH scheduled by the DCI, or based on PDSCHs after the received request (where the ACK of the DCI acts as UE confirmation of the PDSCH, the L1-RSRP request, or both). In some other examples, the DCI may have a DCI format that indicates the L1-RSRP measurement request, or the UE 115-b may receive an radio network temporary identifier (RNTI) that indicates the L1-RSRP measurement request. Alternatively or additionally, the L1-RSRP request may be indicated based on activating or deactivating one or more dedicated DCI bit-fields via RRC or MAC-CE signaling.

In some other examples, the network entity 105-b may transmit the request for DMRS-based L1-RSRP reporting via an SPS-PDSCH configuration message, where the request is included in the RRC configuration of the SPS-PDSCH. Additionally or alternatively, the downlink grant DCI that triggers the SPS-PDSCH may further indicate whether the RRC configured request for L1-RSRP is triggered or not, upon triggering the SPS-PDSCH configuration.

In some other examples, the network entity 105-b may transmit the request for DMRS-based L1-RSRP reporting via a MAC-CE, where the request is activated or deactivated by the MAC-CE. In such cases, the activation or deactivation of the request may be applied after expiration of a time duration (e.g., X ms) which corresponds to a duration of time after the UE 115-b sends HARQ-ACK corresponding to the MAC-CE. In some cases, the MAC-CE may also include one or more serving cell identifiers, one or more bandwidth part identifiers, or both, associated with the request. In such cases, the activation and deactivation of the request may be separately applied to different serving cells or bandwidth parts.

Based on the request, the UE 115-b may also report PDSCH-DMRS based L1-RSRP measurements via a corresponding PUCCH or PUSCH multiplexed with HARQ-ACK bit(s) associated with the corresponding PDSCH (e.g., the L1-RSRP values may be multiplexed with the ACK/NACK bits associated with the same PDSCH.

To further support efficient L1-RSRP reporting, the request for DMRS-based L1-RSRP reporting may further include a reference value for L1-RSRP signaling that the UE 115-b may use to perform differential PDSCH-RSRP quantization. In some examples, the reference L1-RSRP value may be explicitly indicated in the downlink grant DCI. In some other examples, the RRC message or the MAC-CE which activate the one or more DCI bit-fields dedicated to the request may also configure or indicate the reference L1-RSRP. Additionally or alternatively, the DCI bit-fields may include a set of reference L1-RSRP values (e.g., one or more reference L1-RSRP identifiers), and the downlink grant DCI that triggers the request may further indicate one or more of the reference L1-RSRP values to use via one or more selected L1-RSRP identifiers.

In some other examples, one or more reference L1-RSRP values may be signaled explicitly in the downlink grant DCI that triggers the SPS-PDSCH. In some other examples, the SPS-PDSCH configuration may include the one or more reference L1-RSRP values, or the SPS-PDSCH configuration may include a set of multiple reference L1-RSRP values such that the downlink grant DCI (triggering the request for feedback) further indicates one of the reference L1-RSRP values via one or more selected L1-RSRP identifiers.

Additionally or alternatively, the UE 115-b may determine an explicit number of bits to quantize the DMRS-based L1-RSRP feedback. For example, the UE 115-b may be configured with the number of bits, or the UE 115-b may receive a downlink message (e.g., a DCI message, a RRC message, a MAC-CE) that includes an indication of the number of bits to use to quantize the DMRS-based L1-RSRP feedback. In some cases, the UE 115-b may use one or more bits to differentially refer to a threshold reference L1-RSRP value (e.g., −95dBm as indicated by the network as an L1-RSRP error threshold), and to indicate whether the measured L1-RSRP is above or below the threshold reference L1-RSRP value.

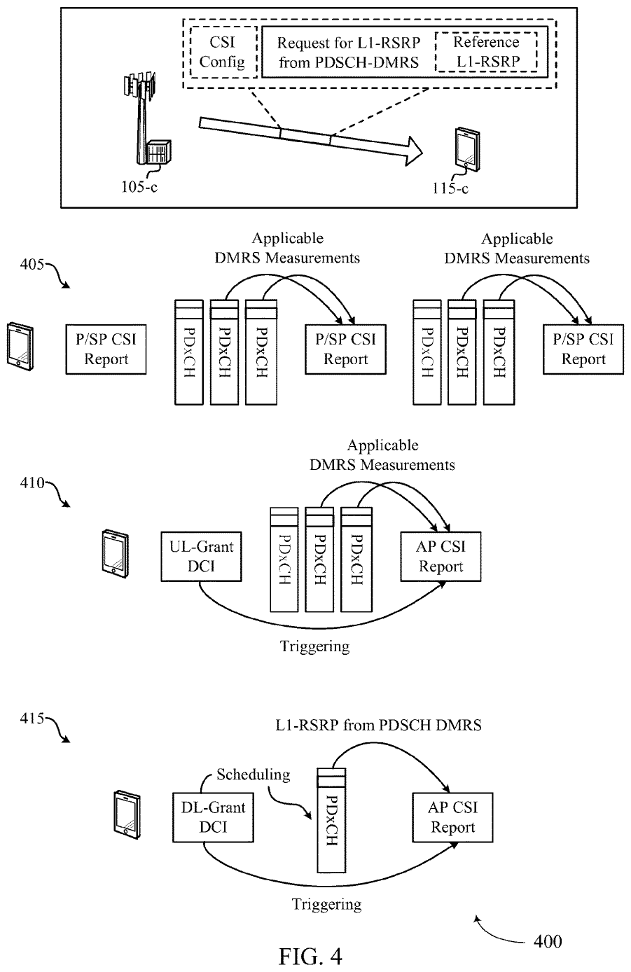

FIG. 4 shows an example of a DMRS-based RSRP reporting configuration 400 that supports beam prediction performance monitoring based on RSRP feedback in accordance with one or more aspects of the present disclosure. For example, the DMRS-based RSRP reporting configuration 400 may support communications between a network entity 105-c and a UE 115-c, which may be examples of network entities 105 and UEs 115 described with reference to FIGS. 1-3. The UE 115-c may in some examples support L1-RSRP reporting based on measurements performed on DMRS of a downlink channel.

In some examples, the network entity 105-c may transmit, to the UE 115-c, a downlink message that includes a request for the UE 115-c to feedback or provide L1-RSRP measurement results based on measurements performed for PDCCH DMRS, PDSCH DMRS, or both. In some examples, the request may be based on one or more configurations of a CSI report setting associated with periodic, semi-periodic, or aperiodic CSI reports. In such examples, the report quantity of the CSI report setting may include one or more PDCCH DMRSs, PDSCH DMRSs, or both that the UE 115-c may use to perform the L1-RSRP measurements.

An RSRP reporting configuration 405 may support DMRS-based L1-RSRP reporting associated with periodic CSI reporting, semi-persistent CSI reporting, or both. The UE 115-c may receive an RRC configuration for an associated CSI report setting, which may include a target quasi-colocation source (e.g., a TypeD-QCL source) associated with the downlink channel DMRS. The UE 115-c may then perform the L1-RSRP measurements using the downlink channel DMRS, and may average the L1-RSRP measurements across each downlink channel DMRS associated with the signaled quasi-colocation type.

In such cases, the downlink channel DMRS may be measured after the CSI reference resource (with respect to the last CSI reporting occasion) or before the CSI reference resource (with respect to the current CSI reporting occasion). Additionally or alternatively, the downlink channel DMRSs that are not associated with the indicated quasi-colocation type (with the signaled target quasi-colocation source) may be ignored for calculating the reported L1-RSRP. In such examples, the UE 115-c may identify applicable DMRS measurements (e.g., downlink channel DMRSs and associated L1-RSRP values that are associated with the indicated quasi-colocation type with the signaled target quasi-colocation source) to include in the CSI report. In some examples, the target quasi-colocation source (e.g., the TypeD-QCL source) may be based on one or more synchronization signal blocks (SSB), one or more CSI-RSs, one or more virtual resources, a TCI-state identifier, or a combination thereof. Additionally or alternatively, the MAC-CE that activates the semi-persistent CSI report may include the target quasi-colocation source. For example, the CSI report setting may configure multiple target quasi-colocation source options, and the MAC-CE may down-select from the options.

An RSRP reporting configuration 410 may support DMRS-based L1-RSRP reporting associated with aperiodic CSI reporting. The UE 115-c may receive a downlink grant DCI that includes the CSI report setting or an aperiodic CSI configuration (e.g., CSI-AssociatedReportConfigInfo). The aperiodic CSI configuration may include a target quasi-colocation source (e.g., a TypeD-QCL source) associated with the downlink channel DMRS. The UE 115-c may then perform the L1-RSRP measurements using the downlink channel DMRS, and may report the L1-RSRP measurements across each downlink channel DMRS associated with the signaled quasi-colocation type. In such cases, the UE 115-c may identify applicable DMRS measurements (e.g., downlink channel DMRSs and associated L1-RSRP values that are associated with the indicated quasi-colocation type with the signaled target quasi-colocation source) to include in the CSI report. In some examples, the CSI report setting may be indicated by down-selecting from multiple CSI report setting options.

An RSRP reporting configuration 415 may support DMRS-based L1-RSRP reporting associated with aperiodic CSI reporting. The UE 115-c may receive a downlink grant DCI that includes the CSI report setting or an aperiodic CSI configuration that schedules a PDSCH. The UE 115-c may measure the L1-RSRP values with respect to the DMRS of the PDSCH scheduled by the downlink grant DCI, and may report the L1-RSRP values via the aperiodic CSI reporting.

To further support efficient L1-RSRP reporting, the request for DMRS-based L1-RSRP reporting may further include a reference value for L1-RSRP signaling that the UE 115-c may use to perform differential PDSCH-RSRP quantization. In some examples, the reference L1-RSRP value may be indicated in an RRC configuration corresponding to the CSI report setting, or by one or more configurations (e.g., CSI-AssociatedReportConfigInfo) associated with an aperiodic CSI report (which may be further based on down-selecting from multiple options RRC configured by the CSI report setting). In some other examples, the reference L1-RSRP value may be indicated via a MAC-CE that activates the semi-persistent CSI report (which may be further based on down-selecting from multiple options RRC configured by the CSI report setting). In some other examples, reference L1-RSRP value may be indicated by the DCI message that triggers the CSI report.

Additionally or alternatively, the UE 115-c may determine an explicit number of bits to quantize the DMRS-based L1-RSRP feedback. For example, the UE 115-c may be configured with the number of bits, or the UE 115-c may receive a downlink message (e.g., a DCI message, a RRC message, a MAC-CE) that includes an indication of the number of bits to use to quantize the DMRS-based L1-RSRP feedback. In some cases, the UE 115-c may use one or more bits to differentially refer to a threshold reference L1-RSRP value (e.g., −95 dBm as indicated by the network as an L1-RSRP error threshold), and to indicate whether the measured L1-RSRP is above or below the threshold reference L1-RSRP value.

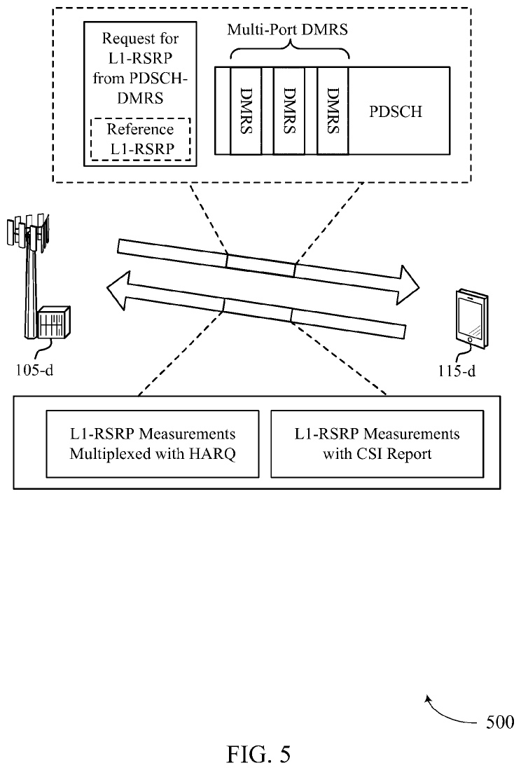

FIG. 5 shows an example of a DMRS-based RSRP reporting configuration 500 that supports beam prediction performance monitoring based on RSRP feedback in accordance with one or more aspects of the present disclosure. For example, the DMRS-based RSRP reporting configuration 500 may support communications between a network entity 105-d and a UE 115-d, which may be examples of network entities 105 and UEs 115 described with reference to FIGS. 1-4. The UE 115-d may in some examples support L1-RSRP reporting based on measurements performed on DMRS of a downlink channel.

In some implementations, the downlink channel DMRS that the UE 115-d uses for L1-RSRP measurement may be a multi-port DMRS or a DMRS associated with multiple TypeD-QCL sources, for example, the downlink channel may be associated with multiple DMRS ports, while different DMRS ports may be associated with different TypeD-QCL sources. In such implementations, the UE 115-d may report multiple L1-RSRPs that are associated with the respective different TypeD-QCL sources associated with the PDSCH DMRS ports.

In some examples, the UE 115-d may report multiple L1-RSRP measurements corresponding to the multiple TypeD-QCL sources by multiplexing the L1-RSRP measurements with HARQ-ACK bits corresponding to a DCI message, a RRC message, or a MAC-CE. In such examples, the UE 115-d may receive an joint indication of one or more reference L1-RSRPs to apply to the multiple TypeD-QCL sources, or the UE 115-d may receive separate indications of the one or more reference L1-RSRPs to apply to respective TypeD-QCL sources. The UE 115-d may additionally or alternatively receive an indication of a number of bits to quantize the L1-RSRP measurements, and the UE 115-d may respectively apply the quantization to the multiple L1-RSRP measurements.

In some other examples, the UE 115-d may receive an indication of the multiple TypeD-QCL sources via signaling associated with the CSI report (e.g., a CSI reporting configuration), and the UE 115-d may send separate feedback for the measured L1-RSRPs associated with the multiple respective DMRS ports.

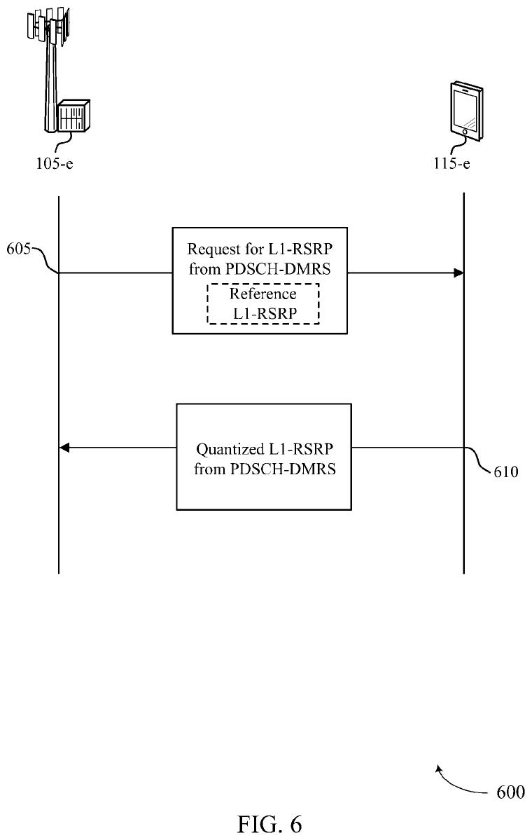

FIG. 6 shows an example of a process flow 600 that supports beam prediction performance monitoring based on RSRP feedback in accordance with one or more aspects of the present disclosure. For example, the process flow 600 may illustrate communications between a UE 115-e and a network entity 105-e, each of which may be examples of corresponding devices described herein, including with reference to FIGS. 1-5.

In the following description of process flow 600, the operations may be performed in a different order than the order shown, or other operations may be added or removed from the process flow 600. For example, some operations may also be left out of process flow 600, may be performed in different orders or at different times, or other operations may be added to process flow 600. Although the UE 115-e and the network entity 105-e are shown performing the operations of process flow 600, some aspects of some operations may also be performed by one or more other wireless devices or network devices.

At 605, the network entity 105-e may transmit, and the UE 115-e may receive, a request for feedback information that is based on one or more RSRP values associated with one or more respective DMRSs of a downlink channel (e.g., a PDCCH or a PDSCH). In some examples, the request may further include at least one reference RSRP value. In some examples, the request may be included in one or more fields of a DCI message that schedules the corresponding downlink channel, and may request that the feedback information be multiplexed with one or more HARQ feedback bits for the downlink channel. In some examples, the UE 115-e may transmit the feedback multiplexed with the HARQ feedback bits based on a format of the DCI message, a RNTI that triggers the transmission of feedback, or both. In some examples, the UE 115-e may receive an RRC message, a MAC-CE, or both, that activate or deactivate the one or more fields of the DCI message, and the UE 115-e may determine to multiplex the feedback information based on the activation or deactivation of the one or more DCI fields.

In some cases, the UE 115-e may transmit a capability message that indicates one or more capabilities of the UE 115-e to perform control channel-based RSRP feedback reporting, data channel-based RSRP feedback reporting, HARQ bit multiplexing with RSRP feedback reporting, CSI-based RSRP feedback reporting, RSRP feedback reporting associated with multiple quasi-colocation sources, or any combination thereof.

In some examples, the UE 115-e may receive an RRC message that includes an SPS configuration for the one or more respective DMRSs of the downlink channel, which also includes the request for feedback information multiplexed with HARQ feedback for the RRC configuration. In some examples, the UE 115-e may receive an activation DCI that activates the SPS configuration and the corresponding request for feedback multiplexed with HARQ bits.

In some other examples, the UE 115-e may receive a MAC-CE that activates the request for feedback information multiplexed with HARQ feedback for the MAC-CE. In some cases, the MAC-CE may further include a serving cell identifier, a bandwidth part identifier, or both, for separate or joint activation via the MAC-CE.

In some examples, the UE 115-e may receive a DCI message that schedules the one or more respective DMRSs of the downlink channel, and one or more fields of the DCI message may include the at least one reference RSRP value to quantize the RSRP feedback. The UE 115-e may receive an RRC message or MAC-CE to activate the one or more fields of the DCI message, and the RRC message or the MAC-CE further indicates the at least one reference RSRP value.

In some examples, the UE 115-e may receive an RRC message that includes an SPS configuration for the one or more DMRSs of the downlink channel, where the RRC message further indicates the at least one reference RSRP value. Additionally or alternatively, the UE 115-e may receive a DCI message that activates the SPS configuration and includes the reference RSRP value. Based on the reference RSRP value, the UE 115-e may quantize the feedback information (with respect to the reference RSRP value) using a quantity of bits indicated via the request or preconfigured for the UE 115-e.

In some examples, the UE 115-e may receive a DCI message, an RRC message, or a MAC-CE that includes one or more configurations of a CSI report setting for persistent CSI reporting, semi-persistent CSI reporting, or both, and the UE 115-e may transmit (e.g., during a CSI reporting occasion) the feedback information that is indicative of an average of the one or more RSRP values associated with a set of quasi-colocated DMRSs of the one or more respective DMRSs. In some examples, the DCI message, the RRC message, or the MAC-CE may also include the reference RSRP value. In some cases, the set of quasi-colocated DMRSs may be associated with a quasi-colocation source that is based on one or more synchronization signal blocks, one or more CSI-RSs, one or more virtual resources, one or more TCI state identifiers, or any combination thereof.

At 610, the UE 115-e may transmit, responsive to the request, the feedback information that is indicative of at least a portion of the one or more RSRP values, and the feedback information is quantized with respect to the at least one reference RSRP value. For example, the feedback information may be multiplexed with one or more HARQ bits, or may be included in CSI reporting.

In some examples, the one or more RSRP values associated with the one or more respective DMRSs correspond to a downlink shared channel, a control channel search space, or control resource set associated with the UE 115-e, and the UE 115-e may report L1-RSRP values measured from a set of successfully decoded control channel candidates.

In some examples, the UE 115-e may transmit the feedback information that is indicative of at least the portion of the one or more RSRP values that are associated with respective quasi-colocation sources of the one or more respective DMRSs and are multiplexed with one or more HARQ bits or transmitted via one or more CSI reports.

The network entity 105-e may in some examples use the feedback information indicative of at least the portion of the one or more RSRP values to perform a beam prediction for the UE 115-e. The network entity 105-e may compare the received one or more RSRP values to a set of predicted RSRP values to identify whether the network entity 105-e has performed an accurate beam prediction, and may schedule the downlink channel on the predicted beam.

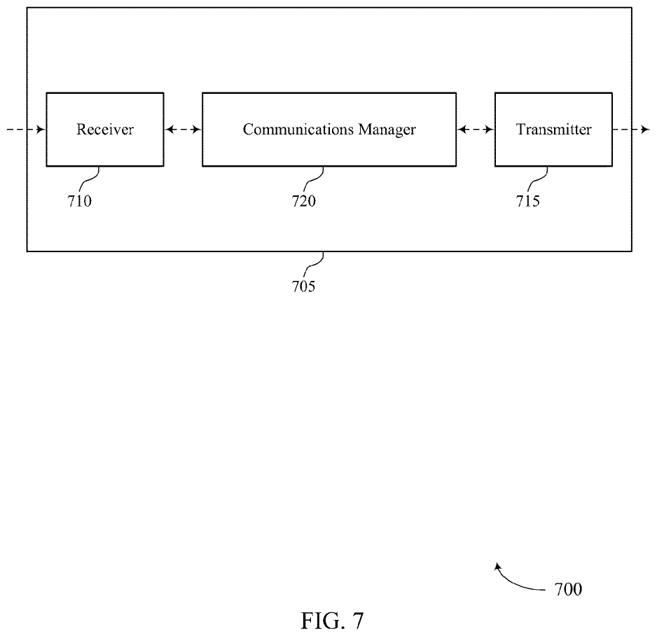

FIG. 7 shows a block diagram 700 of a device 705 that supports beam prediction performance monitoring based on RSRP feedback in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to beam prediction performance monitoring based on RSRP feedback). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to beam prediction performance monitoring based on RSRP feedback). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of beam prediction performance monitoring based on RSRP feedback as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving a request for feedback information that is based on one or more RSRP values associated with one or more respective DMRSs of a downlink channel, the request further including at least one reference RSRP value. The communications manager 720 is capable of, configured to, or operable to support a means for transmitting, responsive to the request, the feedback information that is indicative of at least a portion of the one or more RSRP values, where the feedback information is quantized with respect to the at least one reference RSRP value.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources, more efficient beam measurement techniques, and enhanced RSRP measurement reporting.

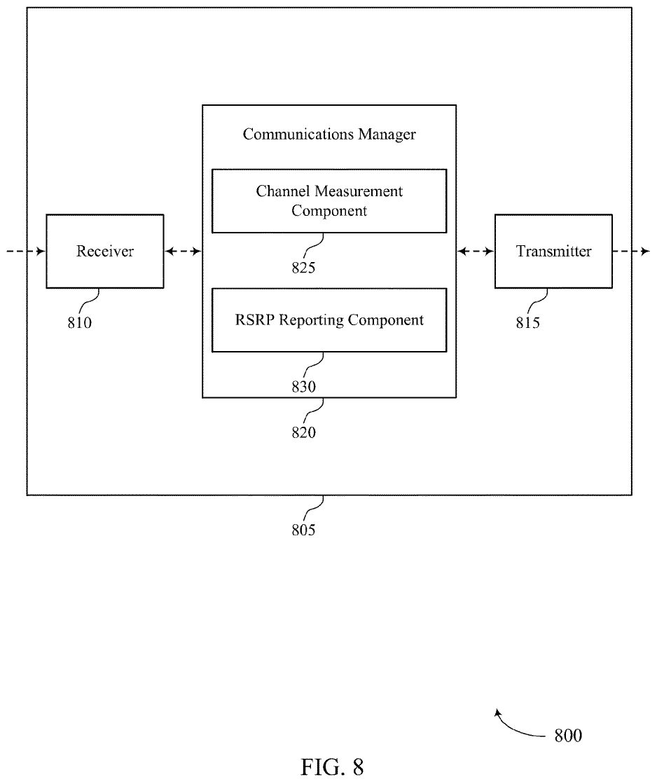

FIG. 8 shows a block diagram 800 of a device 805 that supports beam prediction performance monitoring based on RSRP feedback in accordance with one or more aspects of the present disclosure. The device 805 may be an example of aspects of a device 705 or a UE 115 as described herein. The device 805 may include a receiver 810, a transmitter 815, and a communications manager 820. The device 805, or one of more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to beam prediction performance monitoring based on RSRP feedback). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to beam prediction performance monitoring based on RSRP feedback). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of beam prediction performance monitoring based on RSRP feedback as described herein. For example, the communications manager 820 may include a channel measurement component 825 an RSRP reporting component 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The channel measurement component 825 is capable of, configured to, or operable to support a means for receiving a request for feedback information that is based on one or more RSRP values associated with one or more respective DMRSs of a downlink channel, the request further including at least one reference RSRP value. The RSRP reporting component 830 is capable of, configured to, or operable to support a means for transmitting, responsive to the request, the feedback information that is indicative of at least a portion of the one or more RSRP values, where the feedback information is quantized with respect to the at least one reference RSRP value.

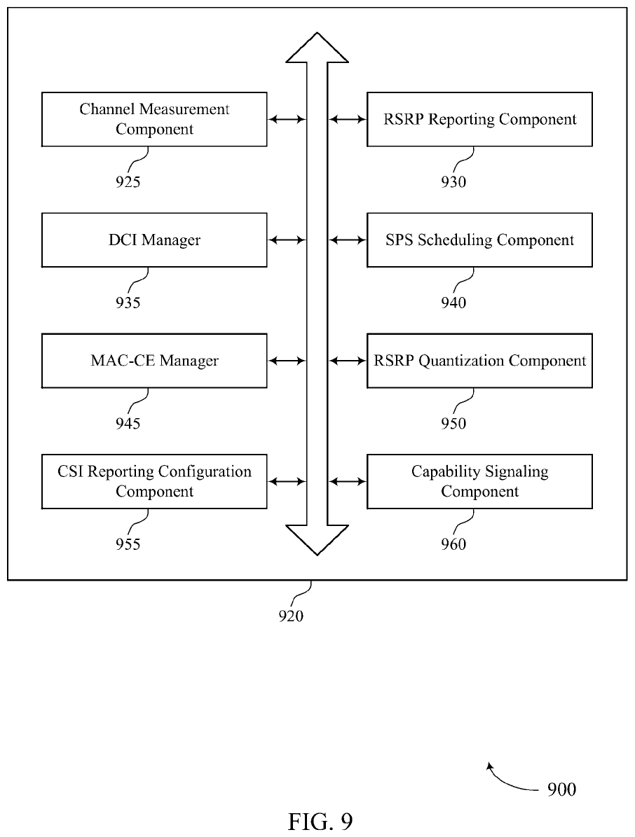

FIG. 9 shows a block diagram 900 of a communications manager 920 that supports beam prediction performance monitoring based on RSRP feedback in accordance with one or more aspects of the present disclosure. The communications manager 920 may be an example of aspects of a communications manager 720, a communications manager 820, or both, as described herein. The communications manager 920, or various components thereof, may be an example of means for performing various aspects of beam prediction performance monitoring based on RSRP feedback as described herein. For example, the communications manager 920 may include a channel measurement component 925, an RSRP reporting component 930, a DCI manager 935, an SPS scheduling component 940, a MAC-CE manager 945, an RSRP quantization component 950, a CSI reporting configuration component 955, a capability signaling component 960, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The channel measurement component 925 is capable of, configured to, or operable to support a means for receiving a request for feedback information that is based on one or more RSRP values associated with one or more respective DMRSs of a downlink channel, the request further including at least one reference RSRP value. The RSRP reporting component 930 is capable of, configured to, or operable to support a means for transmitting, responsive to the request, the feedback information that is indicative of at least a portion of the one or more RSRP values, where the feedback information is quantized with respect to the at least one reference RSRP value.

In some examples, the one or more RSRP values associated with the one or more respective DMRSs correspond to a downlink shared channel, a control channel search space, or control resource set associated with the UE.

In some examples, to support transmitting the feedback information, the RSRP reporting component 930 is capable of, configured to, or operable to support a means for transmitting the feedback information that is indicative of at least a portion of the one or more RSRP values, where the portion of the one or more RSRP values includes RSRP values measured from a set of successfully decoded control channel candidates.

In some examples, the DCI manager 935 is capable of, configured to, or operable to support a means for receiving a DCI message scheduling the one or more respective DMRSs of the downlink channel, where one or more fields of the DCI message include the request for feedback information multiplexed with HARQ feedback for the DCI message. In some examples, the RSRP reporting component 930 is capable of, configured to, or operable to support a means for transmitting, responsive to the request, the feedback information multiplexed with one or more HARQ messages.

In some examples, the RSRP reporting component 930 is capable of, configured to, or operable to support a means for transmitting the feedback information multiplexed with one or more HARQ messages based on a format of the DCI message that triggers transmission of the feedback information, a radio network temporary identifier that triggers transmission of the feedback information, or both.

In some examples, the DCI manager 935 is capable of, configured to, or operable to support a means for receiving an RRC message, a MAC-CE, or both, that activate the one or more fields of the DCI message, where transmission of the feedback information with the one or more HARQ messages is based on an activation or deactivation of the one or more fields of the DCI message.

In some examples, the SPS scheduling component 940 is capable of, configured to, or operable to support a means for receiving an RRC configuration including a semi-persistent scheduling for the one or more respective DMRSs of the downlink channel, where the RRC configuration further includes the request for feedback information multiplexed with HARQ feedback for the RRC configuration. In some examples, the RSRP reporting component 930 is capable of, configured to, or operable to support a means for transmitting, responsive to the request, the feedback information multiplexed with one or more HARQ messages.

In some examples, the DCI manager 935 is capable of, configured to, or operable to support a means for receiving a DCI message that activates the semi-persistent scheduling and further indicates activation of the RRC configuration and corresponding HARQ feedback.

In some examples, the MAC-CE manager 945 is capable of, configured to, or operable to support a means for receiving a MAC-CE that activates the request for feedback information multiplexed with HARQ feedback for the MAC-CE. In some examples, the RSRP reporting component 930 is capable of, configured to, or operable to support a means for transmitting, responsive to the request, the feedback information multiplexed with one or more HARQ messages.

In some examples, the MAC-CE further includes a serving cell identifier, a bandwidth part identifier, or both, for separate or joint activation via the MAC-CE.

In some examples, to support transmitting the feedback information, the RSRP reporting component 930 is capable of, configured to, or operable to support a means for multiplexing the feedback information that is indicative of at least a portion of the one or more RSRP values with one or more HARQ feedback bits associated with the downlink channel.

In some examples, the DCI manager 935 is capable of, configured to, or operable to support a means for receiving a DCI message scheduling the one or more respective DMRSs of the downlink channel, where one or more fields of the DCI message include the at least one reference RSRP value.

In some examples, the DCI manager 935 is capable of, configured to, or operable to support a means for receiving an RRC message or a MAC-CE to activate the one or more fields of the DCI message, where the RRC message or the MAC-CE further indicates the at least one reference RSRP value.

In some examples, the SPS scheduling component 940 is capable of, configured to, or operable to support a means for receiving an RRC configuration including a semi-persistent scheduling for the one or more respective DMRSs of the downlink channel, where the RRC configuration further includes the at least one reference RSRP value.

In some examples, the DCI manager 935 is capable of, configured to, or operable to support a means for receiving a DCI message that activates the semi-persistent scheduling and includes the at least one reference RSRP value.

In some examples, the RSRP quantization component 950 is capable of, configured to, or operable to support a means for quantizing the feedback information with respect to the at least one reference RSRP value using a quantity of bits, where the quantity of bits is a defined value or is received via the request.

In some examples, the CSI reporting configuration component 955 is capable of, configured to, or operable to support a means for receiving an RRC message or a MAC-CE including one or more configurations of a CSI report setting for periodic CSI reporting, semi-persistent CSI reporting, or both. In some examples, the RSRP reporting component 930 is capable of, configured to, or operable to support a means for transmitting, during a CSI reporting occasion, the feedback information that is indicative of an average of the one or more RSRP values associated with a set of quasi-colocated DMRSs of the one or more respective DMRSs.

In some examples, the set of quasi-colocated DMRSs are associated with a quasi-colocation source that is based on one or more synchronization signal blocks, one or more CSI reference signals, one or more virtual resources, one or more transmission configuration indicator state identifiers, or any combination thereof.

In some examples, the CSI reporting configuration component 955 is capable of, configured to, or operable to support a means for receiving a DCI including one or more configurations of a CSI report setting for aperiodic CSI reporting. In some examples, the RSRP reporting component 930 is capable of, configured to, or operable to support a means for transmitting, during a CSI reporting occasion, the feedback information that is indicative of at least the portion of the one or more RSRP values associated with a set of quasi-colocated DMRSs of the one or more respective DMRSs.

In some examples, the CSI reporting configuration component 955 is capable of, configured to, or operable to support a means for receiving a CSI reporting configuration via an RRC message, a MAC-CE, a DCI message, or a combination thereof, where the CSI reporting configuration includes the at least one reference RSRP value.

In some examples, the RSRP reporting component 930 is capable of, configured to, or operable to support a means for transmitting the feedback information that is indicative of at least the portion of the one or more RSRP values, where the one or more RSRP values are associated with respective quasi-colocation sources of the one or more respective DMRSs and are multiplexed with one or more HARQ bits.

In some examples, the RSRP reporting component 930 is capable of, configured to, or operable to support a means for transmitting the feedback information that is indicative of at least the portion of the one or more RSRP values, where the one or more RSRP values are associated with respective quasi-colocation sources of the one or more respective DMRSs and are transmitted in accordance with one or more CSI reports.

In some examples, the capability signaling component 960 is capable of, configured to, or operable to support a means for transmitting a capability message that indicates one or more capabilities of the UE to perform control channel-based RSRP feedback reporting, data channel-based RSRP feedback reporting, HARQ bit multiplexing with RSRP feedback reporting, CSI-based RSRP feedback reporting, RSRP feedback reporting associated with multiple quasi-colocation sources, or any combination thereof.

In some examples, the downlink channel includes a PDSCH or a PDCCH. In some examples, the one or more RSRP values include layer-one (L1) RSRP values.

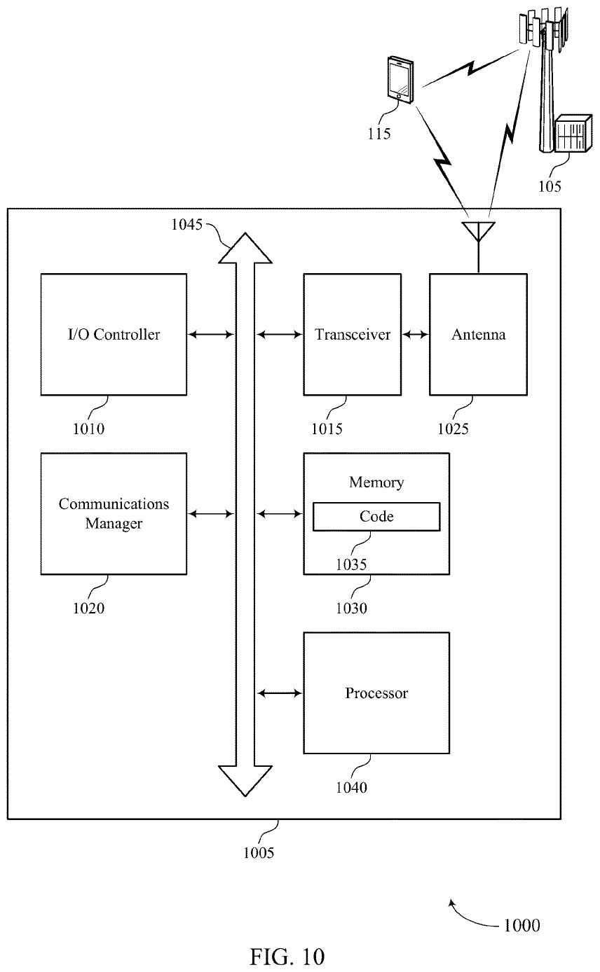

FIG. 10 shows a diagram of a system 1000 including a device 1005 that supports beam prediction performance monitoring based on RSRP feedback in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions.

The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable code 1035 including instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may contain, among other things, a basic I/O system (BIOS) which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting beam prediction performance monitoring based on RSRP feedback). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein.

The communications manager 1020 may support wireless communications in accordance with examples as disclosed herein. For example, the communications manager 1020 is capable of, configured to, or operable to support a means for receiving a request for feedback information that is based on one or more RSRP values associated with one or more respective DMRSs of a downlink channel, the request further including at least one reference RSRP value. The communications manager 1020 is capable of, configured to, or operable to support a means for transmitting, responsive to the request, the feedback information that is indicative of at least a portion of the one or more RSRP values, where the feedback information is quantized with respect to the at least one reference RSRP value.

By including or configuring the communications manager 1020 in accordance with examples as described herein, the device 1005 may support techniques for improved communication reliability, reduced latency, more efficient utilization of communication resources, improved coordination between devices, more efficient beam measurement techniques, and enhanced RSRP measurement reporting, and reduced signaling overhead.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of beam prediction performance monitoring based on RSRP feedback as described herein, or the at least one processor 1040 and the at least one memory 1030 may be otherwise configured to, individually or collectively, perform or support such operations.

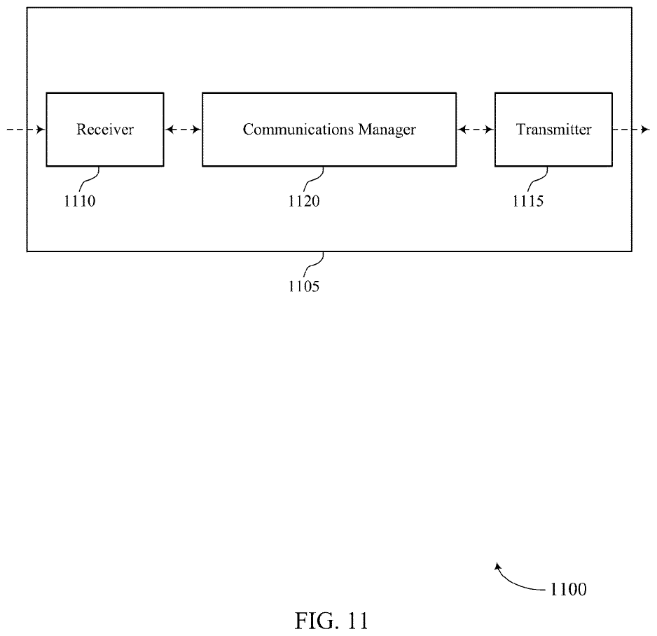

FIG. 11 shows a block diagram 1100 of a device 1105 that supports beam prediction performance monitoring based on RSRP feedback in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas.

Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of beam prediction performance monitoring based on RSRP feedback as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor. If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for transmitting a request for feedback information that is based on one or more RSRP values associated with one or more respective DMRSs of a downlink channel, the request further including at least one reference RSRP value. The communications manager 1120 is capable of, configured to, or operable to support a means for receiving, responsive to the request, the feedback information that is indicative of at least a portion of the one or more RSRP values, where the feedback information is quantized with respect to the at least one reference RSRP value.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for more efficient utilization of communication resources, more efficient beam measurement techniques, and enhanced RSRP measurement reporting.

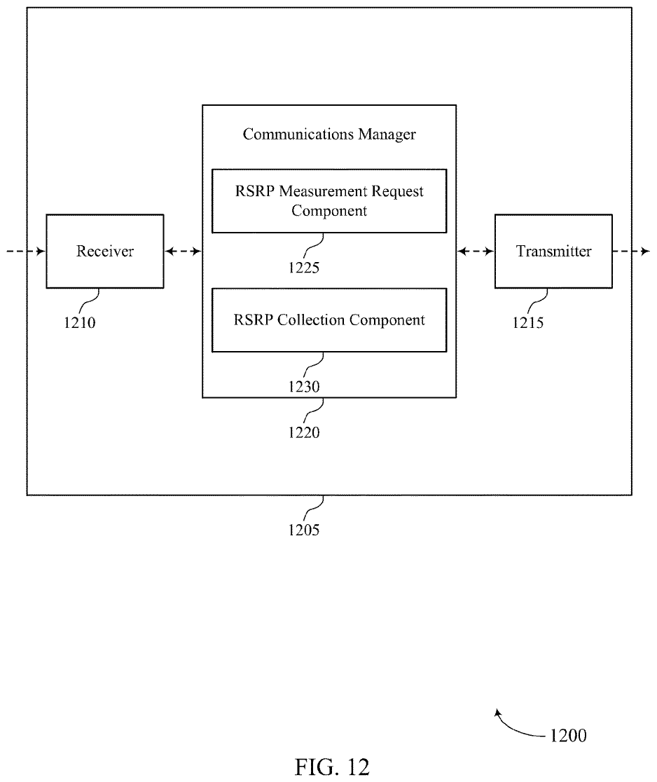

FIG. 12 shows a block diagram 1200 of a device 1205 that supports beam prediction performance monitoring based on RSRP feedback in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one of more components of the device 1205 (e.g., the receiver 1210, the transmitter 1215, and the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas.

Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of beam prediction performance monitoring based on RSRP feedback as described herein. For example, the communications manager 1220 may include an RSRP measurement request component 1225 an RSRP collection component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The RSRP measurement request component 1225 is capable of, configured to, or operable to support a means for transmitting a request for feedback information that is based on one or more RSRP values associated with one or more respective DMRSs of a downlink channel, the request further including at least one reference RSRP value. The RSRP collection component 1230 is capable of, configured to, or operable to support a means for receiving, responsive to the request, the feedback information that is indicative of at least a portion of the one or more RSRP values, where the feedback information is quantized with respect to the at least one reference RSRP value.

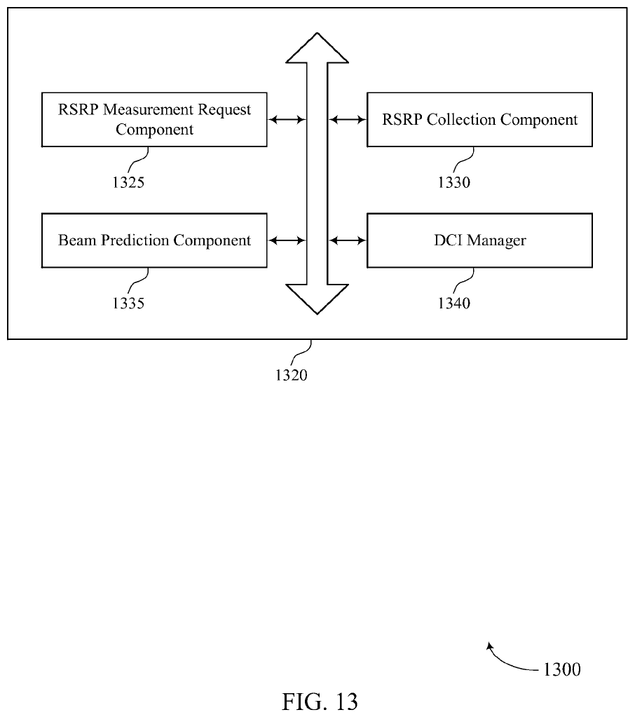

FIG. 13 shows a block diagram 1300 of a communications manager 1320 that supports beam prediction performance monitoring based on RSRP feedback in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of beam prediction performance monitoring based on RSRP feedback as described herein. For example, the communications manager 1320 may include an RSRP measurement request component 1325, an RSRP collection component 1330, a beam prediction component 1335, a DCI manager 1340, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The RSRP measurement request component 1325 is capable of, configured to, or operable to support a means for transmitting a request for feedback information that is based on one or more RSRP values associated with one or more respective DMRSs of a downlink channel, the request further including at least one reference RSRP value. The RSRP collection component 1330 is capable of, configured to, or operable to support a means for receiving, responsive to the request, the feedback information that is indicative of at least a portion of the one or more RSRP values, where the feedback information is quantized with respect to the at least one reference RSRP value.

In some examples, the beam prediction component 1335 is capable of, configured to, or operable to support a means for performing a beam prediction based on a comparison of the received feedback information to a set of predicted RSRP values.

In some examples, the DCI manager 1340 is capable of, configured to, or operable to support a means for transmitting a DCI message scheduling the one or more respective DMRSs of the downlink channel, where one or more fields of the DCI message include the request for feedback information multiplexed with HARQ feedback for the DCI. In some examples, the RSRP collection component 1330 is capable of, configured to, or operable to support a means for receiving, responsive to the request, the feedback information multiplexed with one or more HARQ messages.

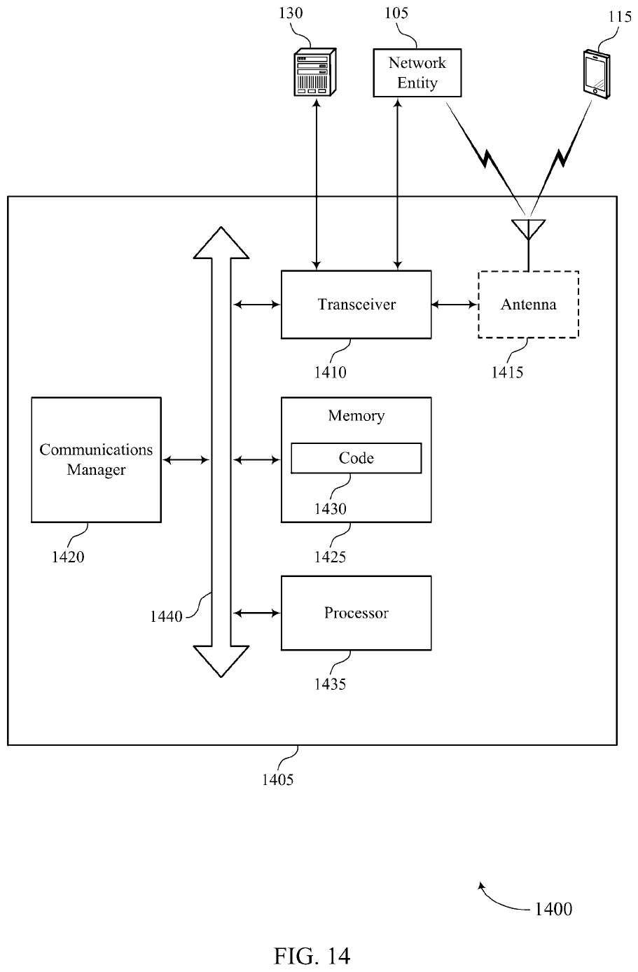

FIG. 14 shows a diagram of a system 1400 including a device 1405 that supports beam prediction performance monitoring based on RSRP feedback in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., a communication link 125, a backhaul communication link 120, a midhaul communication link 162, a fronthaul communication link 168).

The at least one memory 1425 may include RAM, ROM, or any combination thereof. The at least one memory 1425 may store computer-readable, computer-executable code 1430 including instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may contain, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting beam prediction performance monitoring based on RSRP feedback). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425). In some implementations, the at least one processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the at least one processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for transmitting a request for feedback information that is based on one or more RSRP values associated with one or more respective DMRSs of a downlink channel, the request further including at least one reference RSRP value. The communications manager 1420 is capable of, configured to, or operable to support a means for receiving, responsive to the request, the feedback information that is indicative of at least a portion of the one or more RSRP values, where the feedback information is quantized with respect to the at least one reference RSRP value.

By including or configuring the communications manager 1420 in accordance with examples as described herein, the device 1405 may support techniques for improved communication reliability, reduced latency, more efficient utilization of communication resources, improved coordination between devices, more efficient beam measurement techniques, and enhanced RSRP measurement reporting, and reduced signaling overhead.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of beam prediction performance monitoring based on RSRP feedback as described herein, or the at least one processor 1435 and the at least one memory 1425 may be otherwise configured to, individually or collectively, perform or support such operations.

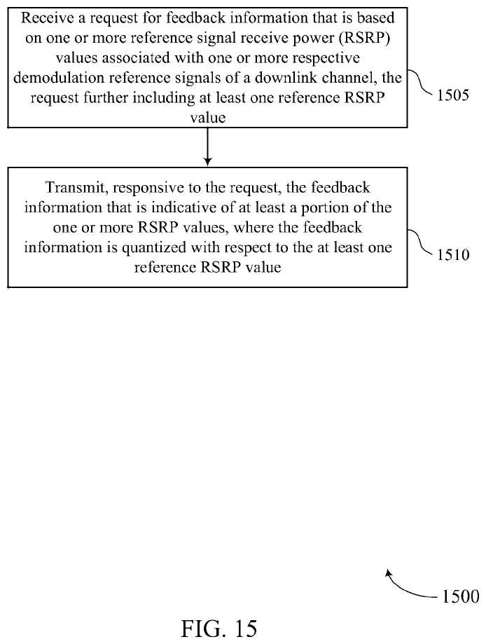

FIG. 15 shows a flowchart illustrating a method 1500 that supports beam prediction performance monitoring based on RSRP feedback in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving a request for feedback information that is based on one or more RSRP values associated with one or more respective DMRSs of a downlink channel, the request further including at least one reference RSRP value. The operations of block 1505 may be performed in accordance with examples as disclosed herein. In some examples, aspects of the operations of 1505 may be performed by a channel measurement component 925 as described with reference to FIG. 9.

At 1510, the method may include transmitting, responsive to the request, the feedback information that is indicative of at least a portion of the one or more RSRP values, where the feedback information is quantized with respect to the at least one reference RSRP value. The operations of block 1510 may be performed in accordance with examples as disclosed herein. In some examples, aspects of the operations of 1510 may be performed by an RSRP reporting component 930 as described with reference to FIG. 9.

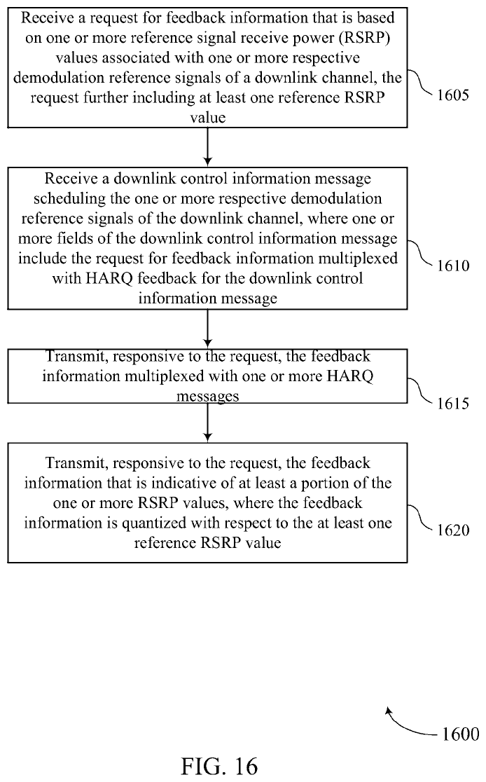

FIG. 16 shows a flowchart illustrating a method 1600 that supports beam prediction performance monitoring based on RSRP feedback in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving a request for feedback information that is based on one or more RSRP values associated with one or more respective DMRSs of a downlink channel, the request further including at least one reference RSRP value. The operations of block 1605 may be performed in accordance with examples as disclosed herein. In some examples, aspects of the operations of 1605 may be performed by a channel measurement component 925 as described with reference to FIG. 9.

At 1610, the method may include receiving a DCI message scheduling the one or more respective DMRSs of the downlink channel, where one or more fields of the DCI message include the request for feedback information multiplexed with HARQ feedback for the DCI message. The operations of block 1610 may be performed in accordance with examples as disclosed herein. In some examples, aspects of the operations of 1610 may be performed by a DCI manager 935 as described with reference to FIG. 9.

At 1615, the method may include transmitting, responsive to the request, the feedback information multiplexed with one or more HARQ messages. The operations of block 1615 may be performed in accordance with examples as disclosed herein. In some examples, aspects of the operations of 1615 may be performed by an RSRP reporting component 930 as described with reference to FIG. 9.

At 1620, the method may include transmitting, responsive to the request, the feedback information that is indicative of at least a portion of the one or more RSRP values, where the feedback information is quantized with respect to the at least one reference RSRP value. The operations of block 1620 may be performed in accordance with examples as disclosed herein. In some examples, aspects of the operations of 1620 may be performed by an RSRP reporting component 930 as described with reference to FIG. 9.

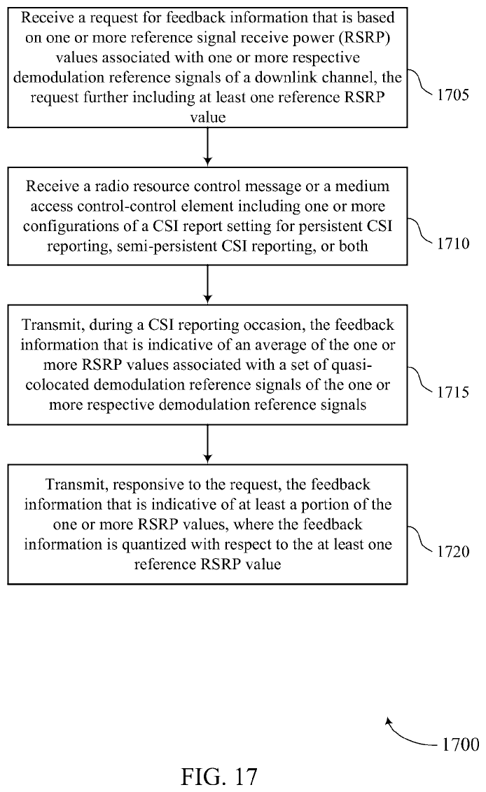

FIG. 17 shows a flowchart illustrating a method 1700 that supports beam prediction performance monitoring based on RSRP feedback in accordance with aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving a request for feedback information that is based on one or more RSRP values associated with one or more respective DMRSs of a downlink channel, the request further including at least one reference RSRP value. The operations of block 1705 may be performed in accordance with examples as disclosed herein. In some examples, aspects of the operations of 1705 may be performed by a channel measurement component 925 as described with reference to FIG. 9.

At 1710, the method may include receiving an RRC message or a MAC-CE including one or more configurations of a CSI report setting for periodic CSI reporting, semi-persistent CSI reporting, or both. The operations of block 1710 may be performed in accordance with examples as disclosed herein. In some examples, aspects of the operations of 1710 may be performed by a CSI reporting configuration component 955 as described with reference to FIG. 9.

At 1715, the method may include transmitting, during a CSI reporting occasion, the feedback information that is indicative of an average of the one or more RSRP values associated with a set of quasi-colocated DMRSs of the one or more respective DMRSs. The operations of block 1715 may be performed in accordance with examples as disclosed herein. In some examples, aspects of the operations of 1715 may be performed by an RSRP reporting component 930 as described with reference to FIG. 9.

At 1720, the method may include transmitting, responsive to the request, the feedback information that is indicative of at least a portion of the one or more RSRP values, where the feedback information is quantized with respect to the at least one reference RSRP value. The operations of block 1720 may be performed in accordance with examples as disclosed herein. In some examples, aspects of the operations of 1720 may be performed by an RSRP reporting component 930 as described with reference to FIG. 9.

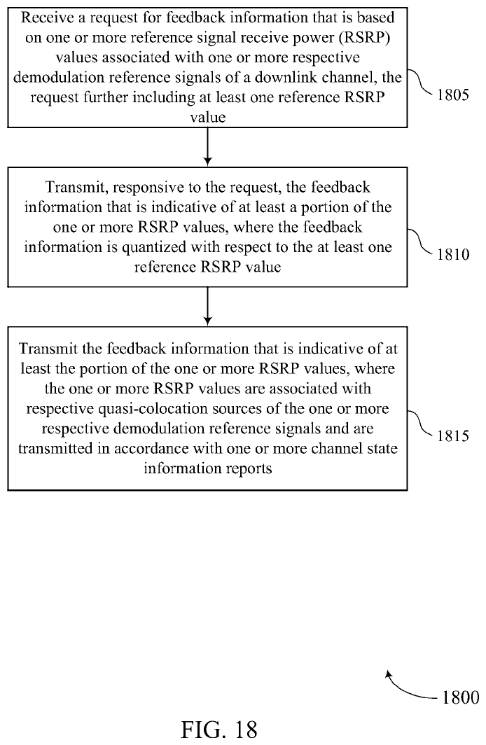

FIG. 18 shows a flowchart illustrating a method 1800 that supports beam prediction performance monitoring based on RSRP feedback in accordance with aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include receiving a request for feedback information that is based on one or more RSRP values associated with one or more respective DMRSs of a downlink channel, the request further including at least one reference RSRP value. The operations of block 1805 may be performed in accordance with examples as disclosed herein. In some examples, aspects of the operations of 1805 may be performed by a channel measurement component 925 as described with reference to FIG. 9.

At 1810, the method may include transmitting, responsive to the request, the feedback information that is indicative of at least a portion of the one or more RSRP values, where the feedback information is quantized with respect to the at least one reference RSRP value. The operations of block 1810 may be performed in accordance with examples as disclosed herein. In some examples, aspects of the operations of 1810 may be performed by an RSRP reporting component 930 as described with reference to FIG. 9.

At 1815, the method may include transmitting the feedback information that is indicative of at least the portion of the one or more RSRP values, where the one or more RSRP values are associated with respective quasi-colocation sources of the one or more respective DMRSs and are transmitted in accordance with one or more CSI reports. The operations of block 1815 may be performed in accordance with examples as disclosed herein. In some examples, aspects of the operations of 1815 may be performed by an RSRP reporting component 930 as described with reference to FIG. 9.

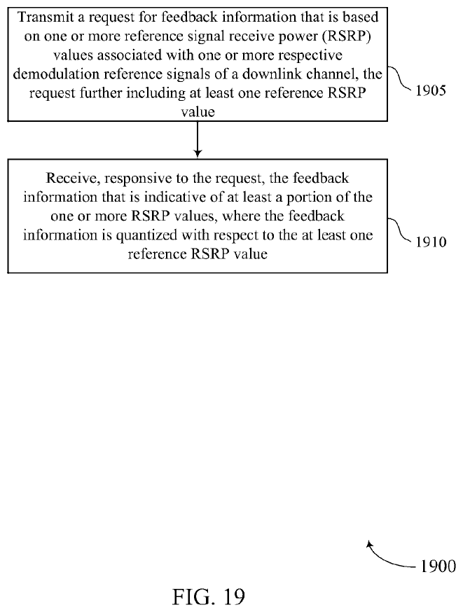

FIG. 19 shows a flowchart illustrating a method 1900 that supports beam prediction performance monitoring based on RSRP feedback in accordance with aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include transmitting a request for feedback information that is based on one or more RSRP values associated with one or more respective DMRSs of a downlink channel, the request further including at least one reference RSRP value. The operations of block 1905 may be performed in accordance with examples as disclosed herein. In some examples, aspects of the operations of 1905 may be performed by an RSRP measurement request component 1325 as described with reference to FIG. 13.

At 1910, the method may include receiving, responsive to the request, the feedback information that is indicative of at least a portion of the one or more RSRP values, where the feedback information is quantized with respect to the at least one reference RSRP value. The operations of block 1910 may be performed in accordance with examples as disclosed herein. In some examples, aspects of the operations of 1910 may be performed by an RSRP collection component 1330 as described with reference to FIG. 13.

The following provides an overview of aspects of the present disclosure:

Aspect 1: A method for wireless communications at a UE, comprising: receiving a request for feedback information that is based at least in part on one or more RSRP values associated with one or more respective DMRSs of a downlink channel, the request further comprising at least one reference RSRP value; and transmitting, responsive to the request, the feedback information that is indicative of at least a portion of the one or more RSRP values, wherein the feedback information is quantized with respect to the at least one reference RSRP value.

Aspect 2: The method of aspect 1, wherein the one or more RSRP values associated with the one or more respective DMRSs correspond to a downlink shared channel, a control channel search space, or control resource set associated with the UE.

Aspect 3: The method of any of aspects 1 through 2, wherein transmitting the feedback information further comprises: transmitting the feedback information that is indicative of at least a portion of the one or more RSRP values, wherein the portion of the one or more RSRP values comprises RSRP values measured from a set of successfully decoded control channel candidates.

Aspect 4: The method of any of aspects 1 through 3, further comprising: receiving a DCI message scheduling the one or more respective DMRSs of the downlink channel, wherein one or more fields of the DCI message comprise the request for feedback information multiplexed with HARQ feedback for the DCI message; and transmitting, responsive to the request, the feedback information multiplexed with one or more HARQ messages.

Aspect 5: The method of aspect 4, further comprising: transmitting the feedback information multiplexed with one or more HARQ messages based at least in part on a format of the DCI message that triggers transmission of the feedback information, a radio network temporary identifier that triggers transmission of the feedback information, or both.

Aspect 6: The method of any of aspects 4 through 5, further comprising: receiving an RRC message, a MAC-CE, or both, that activate the one or more fields of the DCI message, wherein transmission of the feedback information with the one or more HARQ messages is based at least in part on an activation or deactivation of the one or more fields of the DCI message.

Aspect 7: The method of any of aspects 1 through 6, further comprising: receiving an RRC configuration comprising a semi-persistent scheduling for the one or more respective DMRSs of the downlink channel, wherein the RRC configuration further comprises the request for feedback information multiplexed with HARQ feedback for the RRC configuration; and transmitting, responsive to the request, the feedback information multiplexed with one or more HARQ messages.

Aspect 8: The method of aspect 7, further comprising: receiving a DCI message that activates the semi-persistent scheduling and further indicates activation of the RRC configuration and corresponding HARQ feedback.

Aspect 9: The method of any of aspects 1 through 8, further comprising: receiving a MAC-CE that activates the request for feedback information multiplexed with HARQ feedback for the MAC-CE; and transmitting, responsive to the request, the feedback information multiplexed with one or more HARQ messages.

Aspect 10: The method of aspect 9, wherein the MAC-CE further comprises a serving cell identifier, a bandwidth part identifier, or both, for separate or joint activation via the MAC-CE.

Aspect 11: The method of any of aspects 1 through 10, wherein transmitting the feedback information further comprises: multiplexing the feedback information that is indicative of at least a portion of the one or more RSRP values with one or more HARQ feedback bits associated with the downlink channel.

Aspect 12: The method of any of aspects 1 through 11, further comprising: receiving a DCI message scheduling the one or more respective DMRSs of the downlink channel, wherein one or more fields of the DCI message comprise the at least one reference RSRP value.

Aspect 13: The method of aspect 12, further comprising: receiving an RRC message or a MAC-CE to activate the one or more fields of the DCI message, wherein the RRC message or the MAC-CE further indicates the at least one reference RSRP value.

Aspect 14: The method of any of aspects 1 through 13, further comprising: receiving an RRC configuration comprising a semi-persistent scheduling for the one or more respective DMRSs of the downlink channel, wherein the RRC configuration further comprises the at least one reference RSRP value.

Aspect 15: The method of aspect 14, further comprising: receiving a DCI message that activates the semi-persistent scheduling and includes the at least one reference RSRP value.

Aspect 16: The method of any of aspects 1 through 15, further comprising: quantizing the feedback information with respect to the at least one reference RSRP value using a quantity of bits, wherein the quantity of bits is a defined value or is received via the request.

Aspect 17: The method of any of aspects 1 through 16, further comprising: receiving an RRC message or a MAC-CE comprising one or more configurations of a CSI report setting for persistent CSI reporting, semi-persistent CSI reporting, or both; and transmitting, during a CSI reporting occasion, the feedback information that is indicative of an average of the one or more RSRP values associated with a set of quasi-colocated DMRSs of the one or more respective DMRSs.

Aspect 18: The method of aspect 17, wherein the set of quasi-colocated DMRSs are associated with a quasi-colocation source that is based at least in part on one or more synchronization signal blocks, one or more CSI-RSs, one or more virtual resources, one or more transmission configuration indicator state identifiers, or any combination thereof.

Aspect 19: The method of any of aspects 1 through 18, further comprising: receiving a DCI comprising one or more configurations of a CSI report setting for aperiodic CSI reporting; and transmitting, during a CSI reporting occasion, the feedback information that is indicative of at least the portion of the one or more RSRP values associated with a set of quasi-colocated DMRSs of the one or more respective DMRSs.

Aspect 20: The method of any of aspects 1 through 19, further comprising: receiving a channel state information reporting configuration via an RRC message, a MAC-CE, a DCI message, or a combination thereof, wherein the channel state information reporting configuration comprises the at least one reference RSRP value.

Aspect 21: The method of any of aspects 1 through 20, further comprising: transmitting the feedback information that is indicative of at least the portion of the one or more RSRP values, wherein the one or more RSRP values are associated with respective quasi-colocation sources of the one or more respective DMRSs and are multiplexed with one or more HARQ bits.

Aspect 22: The method of any of aspects 1 through 21, further comprising: transmitting the feedback information that is indicative of at least the portion of the one or more RSRP values, wherein the one or more RSRP values are associated with respective quasi-colocation sources of the one or more respective DMRSs and are transmitted in accordance with one or more channel state information reports.

Aspect 23: The method of any of aspects 1 through 22, further comprising: transmitting a capability message that indicates one or more capabilities of the UE to perform control channel-based RSRP feedback reporting, data channel-based RSRP feedback reporting, HARQ bit multiplexing with RSRP feedback reporting, channel state information-based RSRP feedback reporting, RSRP feedback reporting associated with multiple quasi-colocation sources, or any combination thereof.

Aspect 24: The method of any of aspects 1 through 23, wherein the downlink channel comprises a physical downlink shared channel or a physical downlink control channel.

Aspect 25: The method of any of aspects 1 through 24, wherein the one or more RSRP values comprise L1 RSRP values.

Aspect 26: A method for wireless communications at a network entity, comprising: transmitting a request for feedback information that is based at least in part on one or more RSRP values associated with one or more respective DMRSs of a downlink channel, the request further comprising at least one reference RSRP value; and receiving, responsive to the request, the feedback information that is indicative of at least a portion of the one or more RSRP values, wherein the feedback information is quantized with respect to the at least one reference RSRP value.

Aspect 27: The method of aspect 26, further comprising: performing a beam prediction based at least in part on a comparison of the received feedback information to a set of predicted RSRP values.

Aspect 28: The method of any of aspects 26 through 27, further comprising: transmitting a DCI message scheduling the one or more respective DMRSs of the downlink channel, wherein one or more fields of the DCI message comprise the request for feedback information multiplexed with HARQ feedback for the DCI; and receiving, responsive to the request, the feedback information multiplexed with one or more HARQ messages.

Aspect 29: A UE for wireless communications, comprising one or more memories storing processor-executable code, and one or more processors coupled with the one or more memories and individually or collectively operable to execute the code to cause the UE to perform a method of any of aspects 1 through 25.

Aspect 30: A UE for wireless communications, comprising at least one means for performing a method of any of aspects 1 through 25.

Aspect 31: A non-transitory computer-readable medium storing code for wireless communications, the code comprising instructions executable by a processor to perform a method of any of aspects 1 through 25.

Aspect 32: A network entity for wireless communications, comprising one or more memories storing processor-executable code, and one or more processors coupled with the one or more memories and individually or collectively operable to execute the code to cause the network entity to perform a method of any of aspects 26 through 28.

Aspect 33: A network entity for wireless communications, comprising at least one means for performing a method of any of aspects 26 through 28.

Aspect 34: A non-transitory computer-readable medium storing code for wireless communications, the code comprising instructions executable by a processor to perform a method of any of aspects 26 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE), comprising:
one or more memories storing processor-executable code; and
one or more processors coupled with the one or more memories and individually or collectively operable to execute the code to cause the UE to:
receive a request for feedback information that is based at least in part on one or more reference signal receive power (RSRP) values associated with one or more respective demodulation reference signals of a downlink channel, the request further comprising at least one reference RSRP value; and
transmit, responsive to the request, the feedback information that is indicative of at least a portion of the one or more RSRP values, wherein the feedback information is quantized with respect to the at least one reference RSRP value.

2. The UE of claim 1, wherein the one or more RSRP values associated with the one or more respective demodulation reference signals correspond to a downlink shared channel, a control channel search space, or control resource set associated with the UE.

3. The UE of claim 1, wherein, to transmit the feedback information, the one or more processors are individually or collectively further operable to execute the code to cause the UE to:
transmit the feedback information that is indicative of at least a portion of the one or more RSRP values, wherein the portion of the one or more RSRP values comprises RSRP values measured from a set of successfully decoded control channel candidates.

4. The UE of claim 1, wherein the one or more processors are individually or collectively further operable to execute the code to cause the UE to:
receive a downlink control information message scheduling the one or more respective demodulation reference signals of the downlink channel, wherein one or more fields of the downlink control information message comprise the request for feedback information multiplexed with hybrid automatic repeat request (HARQ) feedback for the downlink control information message; and
transmit, responsive to the request, the feedback information multiplexed with one or more HARQ messages.

5. The UE of claim 4, wherein the one or more processors are individually or collectively further operable to execute the code to cause the UE to:
transmit the feedback information multiplexed with the one or more HARQ messages based at least in part on a format of the downlink control information message that triggers transmission of the feedback information, a radio network temporary identifier that triggers transmission of the feedback information, or both.

6. The UE of claim 4, wherein the one or more processors are individually or collectively further operable to execute the code to cause the UE to:
receive a radio resource control message, a medium access control-control element, or both, that activate the one or more fields of the downlink control information message, wherein transmission of the feedback information with the one or more HARQ messages is based at least in part on an activation or deactivation of the one or more fields of the downlink control information message.

7. The UE of claim 1, wherein the one or more processors are individually or collectively further operable to execute the code to cause the UE to:
receive a radio resource control configuration comprising a semi-persistent scheduling for the one or more respective demodulation reference signals of the downlink channel, wherein the radio resource control configuration further comprises the request for feedback information multiplexed with hybrid automatic repeat request (HARQ) feedback for the radio resource control configuration; and
transmit, responsive to the request, the feedback information multiplexed with one or more HARQ messages.

8. The UE of claim 7, wherein the one or more processors are individually or collectively further operable to execute the code to cause the UE to:
receive a downlink control information message that activates the semi-persistent scheduling and further indicates activation of the radio resource control configuration and corresponding HARQ feedback.

9. The UE of claim 1, wherein the one or more processors are individually or collectively further operable to execute the code to cause the UE to:
receive a medium access control-control element that activates the request for feedback information multiplexed with hybrid automatic repeat request (HARQ) feedback for the medium access control-control element; and
transmit, responsive to the request, the feedback information multiplexed with one or more HARQ messages.

10. The UE of claim 9, wherein the medium access control-control element further comprises a serving cell identifier, a bandwidth part identifier, or both, for separate or joint activation via the medium access control-control element.

11. The UE of claim 1, wherein, to transmit the feedback information, the one or more processors are individually or collectively further operable to execute the code to cause the UE to:
multiplex the feedback information that is indicative of at least a portion of the one or more RSRP values with one or more hybrid automatic repeat request (HARQ) feedback bits associated with the downlink channel.

12-13. (canceled)

14. The UE of claim 1, wherein the one or more processors are individually or collectively further operable to execute the code to cause the UE to:
receive a radio resource control configuration comprising a semi-persistent scheduling for the one or more respective demodulation reference signals of the downlink channel, wherein the radio resource control configuration further comprises the at least one reference RSRP value.

15. The UE of claim 14, wherein the one or more processors are individually or collectively further operable to execute the code to cause the UE to:
receive a downlink control information message that activates the semi-persistent scheduling and includes the at least one reference RSRP value.

16-18. (canceled)

19. The UE of claim 1, wherein the one or more processors are individually or collectively further operable to execute the code to cause the UE to:
receive a downlink control information comprising one or more configurations of a channel state information (CSI) report setting for aperiodic CSI reporting; and
transmit, during a CSI reporting occasion, the feedback information that is indicative of at least the portion of the one or more RSRP values associated with a set of quasi-colocated demodulation reference signals of the one or more respective demodulation reference signals.

20. (canceled)

21. The UE of claim 1, wherein the one or more processors are individually or collectively further operable to execute the code to cause the UE to:
transmit the feedback information that is indicative of at least the portion of the one or more RSRP values, wherein the one or more RSRP values are associated with respective quasi-colocation sources of the one or more respective demodulation reference signals and are multiplexed with one or more hybrid automatic repeat request (HARQ) bits.

22. The UE of claim 1, wherein the one or more processors are individually or collectively further operable to execute the code to cause the UE to:
transmit the feedback information that is indicative of at least the portion of the one or more RSRP values, wherein the one or more RSRP values are associated with respective quasi-colocation sources of the one or more respective demodulation reference signals and are transmitted in accordance with one or more channel state information reports.

23-24. (canceled)

25. The UE of claim 1, wherein:
the one or more RSRP values comprise layer-one (L1) RSRP values.

26. A network entity, comprising:
one or more memories storing processor-executable code; and
one or more processors coupled with the one or more memories and individually or collectively operable to execute the code to cause the network entity to:
transmit a request for feedback information that is based at least in part on one or more reference signal receive power (RSRP) values associated with one or more respective demodulation reference signals of a downlink channel, the request further comprising at least one reference RSRP value; and
receive, responsive to the request, the feedback information that is indicative of at least a portion of the one or more RSRP values, wherein the feedback information is quantized with respect to the at least one reference RSRP value.

27. The network entity of claim 26, wherein the one or more processors are individually or collectively further operable to execute the code to cause the network entity to:
perform a beam prediction based at least in part on a comparison of the received feedback information to a set of predicted RSRP values.

28-29. (canceled)

30. A method for wireless communications at a network entity, comprising:
transmitting a request for feedback information that is based at least in part on one or more reference signal receive power (RSRP) values associated with one or more respective demodulation reference signals of a downlink channel, the request further comprising at least one reference RSRP value; and
receiving, responsive to the request, the feedback information that is indicative of at least a portion of the one or more RSRP values, wherein the feedback information is quantized with respect to the at least one reference RSRP value.
